(19) United States
(12) Patent Application Publication
(10) Pub. No.: US 2010/0016073 A1
(43) Pub. Date: Jan. 21, 2010

(54) AUTOMATED AND SECURE DATA COLLECTION FOR SECURING AND MANAGING GAMING NETWORKS

(75) Inventors: Floyd Goldstein, Grass Valley, CA (US); John Goodman, Reno, NV (US); Yung Hua, Sparks, NV (US); David C. Williams, Carson City, NV (US); Fred Nesemeier, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT, Reno, NV (US)

(21) Appl. No.: 12/364,459

(22) Filed: Feb. 2, 2009

Related U.S. Application Data
(63) Continuation-in-part of application No. 11/763,387, filed on Jun. 14, 2007.

(51) Int. Cl. A63F 9/24; A63F 13/00; A63F 13/12

(52) U.S. Cl. 463/29; 463/42; 463/43

(57) ABSTRACT

Data collected by a secure automated data collection system can be used to effectively manage various gaming systems including wired and/or wireless gaming networks. Managing a gaming network can, for example, include securing the gaming network against unauthorized access and/or unauthorized devices, changing the mode and/or manner of communication, and generating and providing alerts. A gaming management system can be operable to monitor transmissions made in a gaming network including transmissions made to and from at least one gaming device, obtain data pertaining to the transmissions, and manage the gaming network based on the data.

### CROSS-REFERENCE TO RELATED APPLICATION

This application is a continuation in part of the U.S. application Ser. No. 11/763,387, entitled “SYSTEM AND METHOD FOR SECURE AUTOMATED DATA COLLECTION” (attorney docket number IGT1P388) and filed on Jun. 14, 2007, which is hereby incorporated herein by reference in its entirety and for all purposes.

### BACKGROUND OF THE INVENTION

Obtaining meter data from gaming machines is important to evaluate revenue generation. It is best to obtain the data on a daily basis to be able to analyze the gaming machine, theme response, and other revenue criteria. For example, if a carousel of gaming machines is not attracting players due to its location, it is best to know immediately so that the casino may change the location of the gaming machines. Additionally, if the players are not attracted to the theme of the game being played, the casino can switch out the games to a more attractive game of chance.

To obtain data from gaming machines, an employee must interrupt game play, open the gaming machine, and manually inspect the meters. This process is labor intensive and costly and the data is subject to human error. Additionally, game play must either be interrupted or the employee must wait for the gaming machine to be free.

Furthermore, a gaming or gaming machine company, such as IGT of Reno, Nev., may rely on the data for revenue generation from participation and/or non-participation games. The data may be important for the calculation of license fees, copyright royalties, and the like. Currently, gaming companies may not obtain the data from the gaming machines on a daily basis, thereby delaying revenue generation. Additionally, clients such as a casino may not want to readily share the data and the data may not be accurate.

Another important consideration is the safety and management of gaming networks. Gaming networks have been recently developed for various gaming activities. More recently, extensive efforts have been made to develop wireless gaming networks and wireless gaming. Gaming networks developed for wagering games can be very complex. Generally, security is major concern of any gaming network used to conduct wagering games.

### SUMMARY OF THE INVENTION

The invention pertains to improved techniques for managing and securing gaming networks. In accordance with one aspect of the invention, data collected by a secure automated data collection system can be used to effectively manage various gaming systems including wired and/or wireless gaming networks. Managing a gaming network can, for example, include securing the gaming network against unauthorized access and/or unauthorized devices, changing the mode and/or manner of communication, and generating and providing alerts. In accordance with one embodiment of the invention, a gaming management system can be operable to monitor transmissions made in a gaming network including transmissions made to and from at least one gaming device, obtain data pertaining to the transmissions, and manage the gaming network based on the data.

Some implementations of the invention provide methods for managing a wireless gaming network. The wireless gaming network may include at least a first gaming device operable to receive wireless transmissions from at least a second device and operable to obtain an outcome of a game. Some such methods include these steps: monitoring transmission made in the wireless gaming network including wireless transmissions made to and from the first gaming device; obtaining, based on the monitoring, wireless transmission data pertaining to wireless transmissions made to a first gaming device; and managing the wireless gaming network based on the wireless transmission data.

The monitoring of the wireless transmissions may involve monitoring transmissions to and/or from the first gaming device without interfering with the outcome of the game. The obtaining may comprise collecting the wireless transmission data as collected transmission data and providing the collected data for processing. The managing of the wireless gaming network may involve processing the collected data and determining, based on the processing of the collected data, whether an unauthorized transmission has been sent to the first gaming device. The method may also involve processing the wireless transmission data and determining, based on the processing of the wireless transmission data, whether authorized transmission has been sent to the first gaming device.

The monitoring of the wireless transmissions may be performed by an endpoint device that cannot access the first gaming device. According to some such implementations, the endpoint device cannot be accessed by any other device. The endpoint device may be operable to send the transmission data to another device. According to some such implementations, the endpoint device cannot be accessed by any other device except a data storage/processing system. The endpoint device may be operable to send the transmission data to another device. For example, the endpoint device may be operable to send the transmission data to a data storage component operable to store the transmission data. The receiving device and/or system may include a processing component (such as a logic system) operable to process the transmission data.

The invention can be implemented in numerous ways, including, for example, as a method, as an apparatus, as software stored on one or more computer readable media and/or as a system (e.g., as one or more stand-alone or interconnected computing devices). A computer readable medium may include executable computer program code stored in a tangible form and having instructions for controlling one or more devices to perform, at least in part, one or more methods described herein.

Alternative implementations of the invention provide a wireless gaming management system for managing a wireless gaming network. One such wireless gaming management system includes a data collection component operable to do the following: monitor a wireless gaming network for wireless transmissions made in wireless gaming network including wireless transmission to and/or from at least a first gaming device in the wireless gaming network, wherein the first gaming device is operable to receive wireless transmissions at least from a second device and obtain an outcome of a game managed by a gaming entity; obtain at least wireless transmissions made to and from the first gaming device as collected transmission data; and a data storage and processing component. The game may be a wagering game.

Managing the gaming network may involve securing the gaming network against unauthorized access and/or unauthorized devices, changing a mode and/or manner of communication in the gaming network, as well as generating and/or providing alerts regarding the gaming network. The data storage and processing component may include a data storage (or data concentrator) component operable to store the collected data.

The data storage and processing component may be operable to do the following: obtain the collected transmission data from the data collection component; process the collected data; and manage the wireless gaming network based on the processing of the collected data. The data storage and processing component may include a data processing component (such as a logic system comprising one or more logic devices) operable to obtain and/or process the collected data. The data processing component may include a server component. The data collection component may be configured to avoid interfering with operations relating to the game. The data collection component may be prevented from accessing the first gaming device. The data collection component may be prevented from interfering with gaming operations of the first gaming device.

The data collection component may include an endpoint component operable to monitor wireless transmissions to the first gaming device. In some such implementations, the endpoint component is configured to avoid interfering with the gaming operations of the first gaming device. The endpoint component may be operable to monitor wireless transmissions to and/or from the first gaming device. However, in some implementations, the endpoint component is operable to communicate only with the data storage and processing component.

The endpoint component may, for example, comprise a ZigBee endpoint that is operable to communicate only with one or more designated ZigBee coordinators of the data storage and processing component. The ZigBee end-device(s) may be configured to transmit and receive messages but not operable to perform any routing operations.

The one or more ZigBee end-devices may be operable to transmit the collected data to one or more ZigBee coordinator devices that are operable to effectively initiate and/or control the wireless gaming network. The ZigBee coordinator device(s) may be further operable to receive and store the collected data. The ZigBee coordinator device(s) may be further operable to perform one or more of the following: store information regarding the wireless gaming management system; store information regarding the wireless gaming network; receive the collected data; store the collected data; process the collected data; send the collected data to one or more processing components for processing; provide access to the collected data; or allow one or more processing components to access the collected data.

Securing the gaming network may involve one or more of the following: detecting unauthorized communication in the wireless gaming network; detecting unauthorized data transmissions; detecting an unauthorized device; detecting unauthorized communication by an authorized device; detecting unauthorized data transmissions by an authorized device; detecting unauthorized communication by an unauthorized device; or detecting unauthorized data transmissions by an unauthorized device. The one or more attributes regarding the wireless transmission may include one or more of the following: one or more attributes associated with the signal transmission; one or more attributes associated with signal transmission of a wireless transmission; strength of signal transmission; strength of wireless signal transmission; channel of transmission, channel of wireless signal transmission; one or more attributes associated with transmitted content; one or more attributes associated with content transmitted wirelessly; encryption keys used to encrypt the transmitted content; rate of data transfer; originating location of transmission; proximity of transmission; or one or more identifiers associated with one or more devices transmitting the wireless transmission.

Obtaining the wirelessly transmitted data may involve collecting content of data transmitted in the wireless gaming network and/or collecting one or more attributes regarding wireless transmission in the wireless gaming network. Managing of the wireless gaming network may involve determining, based on the content of data transmitted and/or one or more attributes of transmission, whether an attempt has been made to breach the security of the wireless gaming network and/or whether the security of the wireless gaming network has been breached.

The data collection component may include an endpoint component operable to collect content wirelessly transmitted. The endpoint component may be operable to collect one or more attributes regarding wireless transmissions to and/or from the first gaming device. Other aspects and advantages of the invention will become apparent from the following detailed description, taken in conjunction with the accompanying drawings, illustrating by way of example some principles of the invention.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention.

FIG. 1 illustrates a block diagram of a system to automatically collect data from a plurality of gaming machines.

FIG. 2 is a block diagram of an endpoint and concentrator.

FIG. 3 illustrates a block diagram of the system to automatically collect data.

FIG. 4 is a flow diagram illustrating a method to automatically collect data.

FIG. 5A depicts a gaming management system in a gaming network in accordance with one embodiment of the invention.

FIG. 5B depicts a method for managing a gaming network in accordance with one embodiment of the invention.

FIG. 6 depicts a wireless gaming management system that can effectively manage a wireless gaming network.

FIG. 7A depicts a wireless gaming management system in accordance with another embodiment of the invention.

FIG. 7B depicts a method for collecting transmission data in accordance with one embodiment of the invention.

FIG. 7C depicts a method for providing transmission data in accordance with one embodiment of the invention.

FIG. 7D depicts a method for managing a wireless gaming network and exemplary management activities in accordance with one embodiment of the invention.

FIG. 8 is block diagram of a gaming machine in communication with a wireless game player.

FIG. 9 depicts another video gaming machine suitable for use with the present invention.

FIG. 10 is a block diagram of the internal components of a gaming machine and a wireless game player.

FIG. 11 is a block diagram of a network of gaming machines and wireless game players.

FIG. 12 depicts an exemplary network infrastructure for providing a gaming system having one or more gaming machines illustrated in block diagram format in accordance with one embodiment of the invention.

### DETAILED DESCRIPTION

As noted in the background section, gaming networks and wireless gaming networks in particular have recently been developed. Gaming networks can be very complex. As such, managing a gaming network can be very difficult and error-prone especially if human operators are used. Generally, it is very important to secure gaming networks. However, ensuring the security of gaming networks conducting wagering games is generally difficult partly because of the amount of money at stake. In particular, securing wireless gaming network can be very challenging as they may be more susceptible to malicious attacks. Accordingly, improved techniques for managing and securing gaming networks are needed and would be very useful.

The invention pertains to improved techniques for managing and securing gaming networks. In accordance with one aspect of the invention, data collected by a secure automated data collection system can be used to effectively manage various gaming systems including wired and/or wireless gaming networks. Managing a gaming network can, for example, include securing the gaming network against unauthorized access and/or unauthorized devices, changing the mode and/or manner of communication, and generating and providing alerts. In accordance with one embodiment of the invention, a gaming management system can be operable to monitor transmissions made in a gaming network including transmissions made to and from at least one gaming device, obtain data conveyed in those transmissions, and manage the gaming network based on the data.

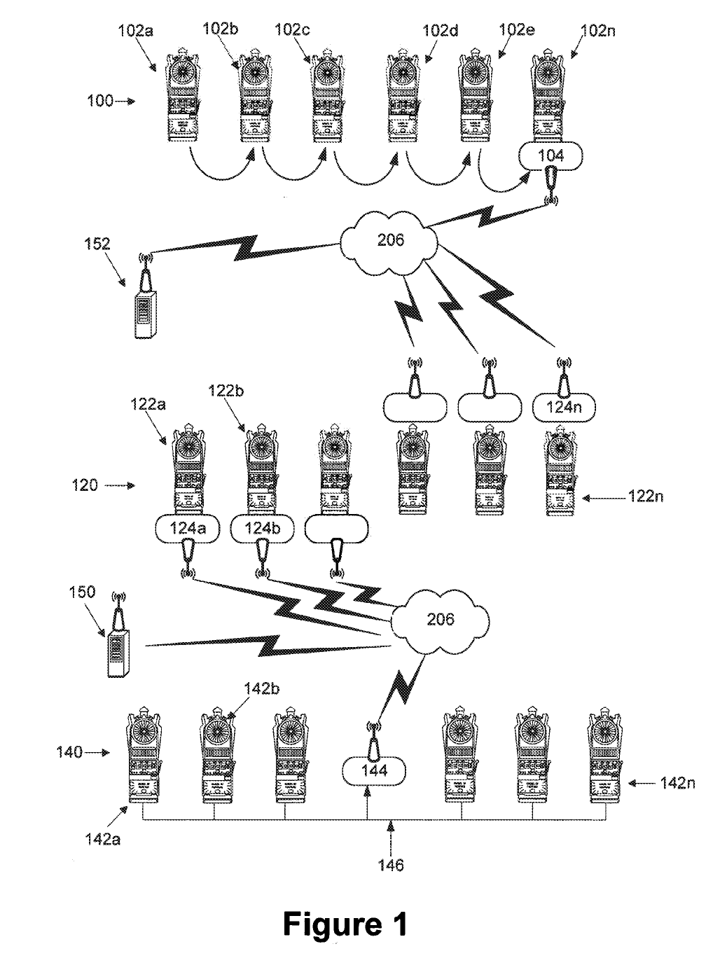

FIG. 1 illustrates a block diagram of a system to automatically collect data from a plurality of gaming machines. An endpoint may be used to retrieve and collect data from the gaming machine, such as meter data, player tracking data, and any other data requested by a user. The endpoint may contain limited functionality to talk with other network devices and may not be configured to relay data to other endpoints. This allows the endpoint to have less memory and cost less to manufacture. However, the endpoints may be able to relay data to other endpoints for fault tolerance systems as further described below. A carousel as used herein describes a plurality of gaming machines grouped together in one location, such as a “bank” of gaming machines. Although FIG. 1 illustrates six gaming machines in each carousel, any number of gaming machines may be formed in a carousel. As illustrated in carousel 100, gaming machines 102a-e, 102n (where n is an integer) may be coupled to each other as a “series” or “line” topology such that the data may be transmitted from gaming machine 102a to gaming machine 102b, from gaming machine 102b to gaming machine 102c, and the like, where the data are collected at endpoint 104 in gaming machine 102n. Alternatively, as illustrated in carousel 120, each gaming machine 122a, 122b, 122n may have its own endpoint 124a, 124b, 124n to collect data from its respective gaming machine. With this “star” topology, the concentrator 150 serves as the hub of the star configuration.

In another embodiment, as illustrated in carousel 140, the endpoint 144 may be remote from the gaming machines 142a, 142b, 142n. Each gaming machine 142a, 142b, 142n may be communicatively coupled to endpoint 144 or similar to carousel 100, the data may be transmitted to a designated gaming machine, such as gaming machine 142b, to be transmitted to endpoint 144. The gaming machines 142a, 142b, 142n may be coupled to the endpoint through any known means including but not limited to a serial SAS 146, RS-232, universal serial bus, fiber loop, Ethernet, Data Collection Systems (DCS) port loop, direct wire connection, and the like.

The data collected from the endpoints 104, 124a,b,n, 144 may be used for a variety of purposes such as product marketing, theme response, and revenue analysis. The data may also be used to calculate revenues received from participation games, licensee fees, copyright fees, and the like. The meter data collected from the participation games may be used to evaluate the location of the gaming machine carousels, the game of chance played on the gaming machines, and/or other criteria to determine the effectiveness of the gaming machines as well. However, a client may refuse to submit the data to the gaming or gaming machine company. Thus, it would be beneficial to present the data in a way that would benefit both the gaming or gaming machine company and the client such as a casino. Alternatively, the information may be used to incentivize the client to provide accurate data to the gaming machine company. For example, the data may include player tracking information to evaluate the players that play the gaming machines. This would benefit the casino by helping them identify, analyze data relating to, and/or direct offers and/or services to high rollers. For example, a casino may direct special services to players of machines indicating a large “coin in” to keep the player interested in playing the gaming machine.

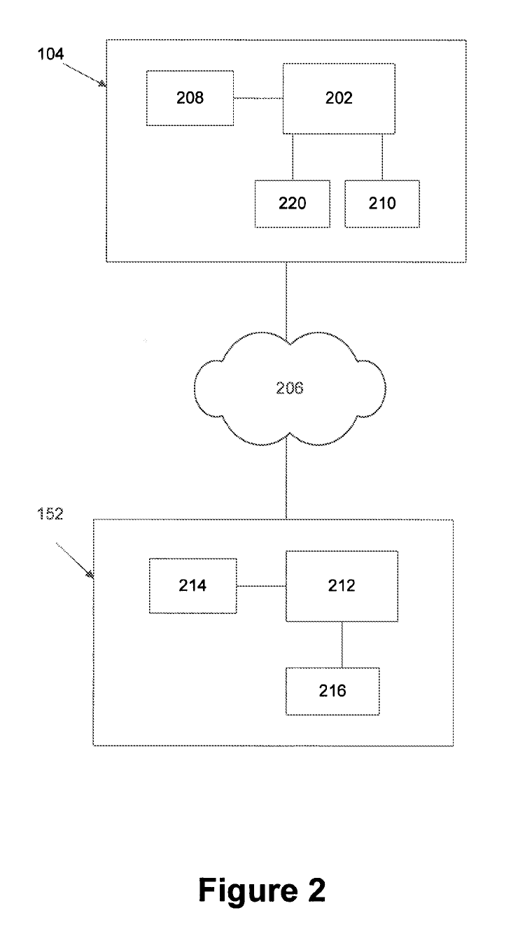

The endpoints may collect the data from the gaming machines at predetermined time intervals such as once a day or several times a day. Alternatively, the endpoints may collect the information upon the occurrence of an event, e.g., when a predetermined amount of data has been acquired, when resource utilization (e.g., network utilization or gaming machine utilization) drops below a predetermined level, when an internal alarm is triggered, etc. In one such example, endpoint 104 may have an internal alarm (illustrated in FIG. 2) to signal the collection of data from the gaming machines and to “push” or transmit the data to the remote gateway or concentrator 152. The time intervals at which the endpoints 104, 124a-n, 144 communicate with the concentrators 152, 150 may be intentionally varied or randomized in order to increase system security. Alternatively, or additionally, the endpoints may collect or transmit such information upon demand. For example, a casino administrator may request or “pull” such data to determine the effectiveness of a promotional event, to evaluate the popularity of a new gaming machine or a new wagering game, to evaluate patterns relating to a new casino floor layout, etc.

FIG. 2 is a block diagram of an endpoint and concentrator. Parts of the endpoint and remote gateway or concentrator will be described though it is not intended to be limiting, as other hardware such as general input/output ports, universal serial bus ports, non-volatile random access memories, field programmable gate arrays, and the like may be used as necessary. In some implementations, endpoint 104 may be configured for communication with concentrator 152 via wireless means. For example, endpoint 104 may be configured for communication with concentrator 152 via a wireless personal area network (WPAN) 206 according to a protocol such as Infrared Data Association (IrDA), Bluetooth, Ultra-wideband (UWB), Z-Wave, ZigBee, etc. In some implementations, another communication protocol (e.g., SAS, Game to System (G2S), etc.), that may be implemented to interoperate with the industry-standard communication protocols such as those prescribed by the Gaming Standards Association. Accordingly, endpoint 104 may be a device that is configured for communication according to an appropriate protocol. In some implementations, endpoint 104 may comprise a device such as an XBee™ or XBee-PRO™ ZigBee module sold by MaxStream of Orem, Utah. The endpoint 104 may have a processor 202 to receive and process the data signals from the gaming machines and/or concentrator 152. The processor 202 or (any other logic device) may be configured to implement a filter to enable the queries of the gaming machine meters and disable all other messages, in particular, transmission of commands to the game which could affect game operation or settings. Alternatively, or additionally, the endpoint may be programmed to not interrupt or control game play on the gaming machine. Thus, data may be collected without interrupting game play on the gaming machine.

Prior to being transmitted, the data signals may be encrypted to increase security. Any known means such as advanced encryption standard (AES), data encryption standard (DES), secure shell (SSH), secure socket layer (SSL) or transport layer security (TLS), or the like may be used.

The endpoint 104 may have a memory 208 coupled to the processor 202 to store any data. The processor 202 may be coupled to an alarm 210, the activation of which triggers the push of data to the concentrator 152. The alarm may be synchronized with the time in the concentrator 152 by a synchronizer 216. The concentrator 152 may comprise components or devices for providing suitable communication, networking, processing, and memory storage means to provide the functionality required by a user. The concentrator 152 may have a processor 212 and/or other logic device(s), e.g., to receive and process the data signals received from the endpoint 104 via the WPAN 206. The processor 212 may be coupled to a memory 214 and a synchronizer 216. The synchronizer 216 may be used to synchronize the alarm 210 on the endpoint 104 with the time on the synchronizer 216.

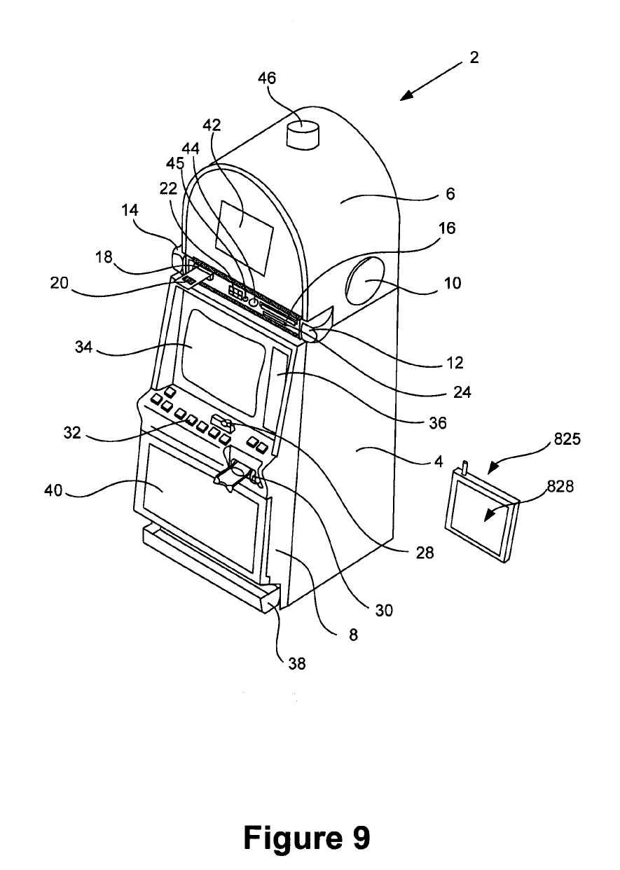

In addition to collecting meter data to gain information to increase revenue, it is important to attract clients and customers to the gaming machines. To attract players, the synchronizer 216 may be used to synchronize visual and/or audio effects on the plurality of gaming machines in a carousel. For example, the synchronizer may transmit a synchronization protocol signal to the endpoint to synchronize lights (e.g., the lights positioned atop wager gaming machines, which are known as “candles”) and speakers (see FIG. 9) in a way that would direct a player's eyes and ears to the carousel. This synchronization may also be used for other purposes, such as to signal the direction to a fire escape exit in case of a fire. For example, the candles may continuously light up starting with gaming machines 102c and 102d, followed by the candles from gaming machine 102b and 102e, which is then followed by candles from gaming machine 102a and 102n, and the pattern may be repeated. The candles may light up in different or the same colors. Simultaneously, an audio message may be played to further attract a player's attention. In another implementation, the gaming machine displays 45 or 34 may be synchronized to illustrate a feature to attract a player. For example, an animated character may appear to “jump” from one gaming machine to the next to attract a player's attention. It will now be realized that other means to synchronize visual or audio effects may be utilized.

The WPAN 206 may be configured for communication via any appropriate network standard, but in this example WPAN 206 is configured for communication via ZigBee. ZigBee is a specification for high level communication protocols using small, low-power digital radios based on the IEEE 802.15.4 standard for wireless PANs. ZigBee can support applications requiring low data rates and low power consumption. ZigBee network topologies create a wireless PAN based on communicating over a selected channel. The ZigBee devices typically remain on the same channel for a significant period of time even if the channel becomes noisy or has detrimental outages and there previously was no mechanism for monitoring or switching channels. Thus, to monitor the channels for noise or outages, a “snooper” or channel agent 220 on the endpoint 104 may be used.

The channel agent 220 may communicate with the concentrator 152 to determine what channel the concentrator 152 is using and analyze the channel for noise, outages, and other criteria. The channel agent 220 may also analyze free unassigned communication channels and determine whether a channel change is necessary to increase transmission reliability. If signal quality on the channel being used by the concentrator 152 falls below a predefined threshold such that a channel change is necessary, the channel agent 220 may send a signal to the concentrator 152 to use a different communication channel. Additionally, the channel agent 220 may continuously monitor the communication channels to pre-select a communication channel for a new device used within the ZigBee network.

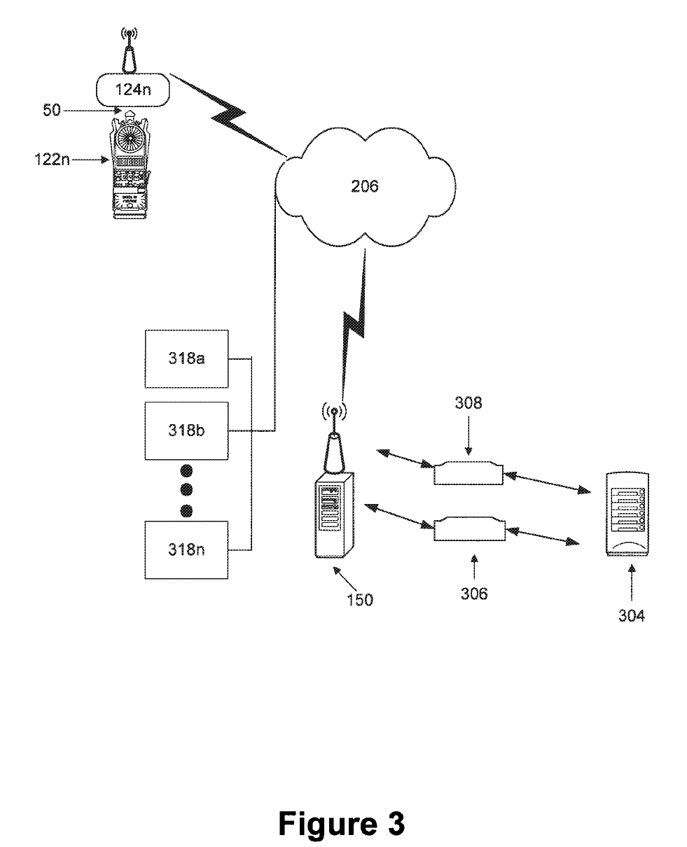

FIG. 3 is a block diagram that illustrates one simplified example of a system for automatically collecting data. In some implementations, concentrator 150 may initiate a process of transmitting data from concentrator 150 to the remote collection sever 304. For example, concentrator 150 may send an indication to remote collection server 304 that data will be pushed from the concentrator 150 to the remote collection sever 304 at a particular time, at brief predefined time intervals, upon the occurrence of an event, etc. The concentrator 150 may communicate with the collection server 304 in various ways, e.g., via a cellular modem 306. However, this is not meant to be limiting as other alternative means of communication with collection server may be used, such as an analog modem with Ethernet 308, communication over a wide area network (WAN) such as the Internet, a public switch connection, or the like. However, the use of a cellular modem 306 or the like may increase data security because the data are communicated over a cellular network and not, e.g., a public WAN. Additionally, the information may be transmitted briefly and infrequently, such as once a day, which makes it more difficult for a security breach to occur without knowing the predefined time intervals set by the concentrator 150. The time intervals at which the concentrator communicates with the remote collection server may be intentionally varied or randomized in order to increase system security. Security may be further increased since it is not necessary that the concentrator 150 be in constant communication or connection with the collection server 304. Additionally, the information obtained by the remote collection server 304 will be accurate and current and the cost of manually reading the meters will be reduced.

The concentrator 150 may also synchronize its time with the collection server 304. The synchronizer 216 may synchronize the time in the concentrator 150 with the master timer on the collection server 304. Thus, the time on the collection server 304, concentrator 150, and endpoints 124n will be the same to ensure that the push of data from the endpoint to the collection server 304 occurs simultaneously.

Wireless modules may be moved around. Although such portability may be generally desirable, this feature can occasionally create a challenge to determine where a module is located. Therefore, in some implementations, a signal may be sent to an endpoint that causes a beeper, a beacon (or the like) to be activated. Such implementations may facilitate the location of particular endpoint by following the sound. For example, a beeper would allow a service technician to find a particular endpoint on a casino floor. In some such implementations, a signal may be sent from the remote collection server to the concentrator and from the to the endpoints. The signal may cause a beeper, a beacon, etc., of a particular endpoint to turn on, thereby facilitating the location of the endpoint.

One type of data that may be transmitted to the concentrator 150 is an attendant signal. Currently on gaming machines, when a player needs assistance, the player may press a call attendant button to light the candle 50 on the gaming machine 122n. The player will be helped only when an attendant notices the lighted candle. To allow for faster service, a player may press the call attendant button and the signal may be transmitted from the gaming machine 122n to the endpoint 124n and transmitted to the concentrator 150 via WPAN 206. The concentrator 150 will receive the signal, process the signal as an attendant signal, and broadcast the transmission to at least one attendant receiver 318a, 318b, 318n via the wireless PAN 206 or any other network. The signal may include information to identify the gaming machine and location of the gaming machine. The signal may be received by the attendant receiver 318a, 318b, 318n in any known manner such as by visual, audio, vibration, or any other similar means. The signal may be broadcast to several attendant receivers 318a, 318b, 318n and any attendant that is closest to the gaming machine may provide assistance. Alternatively, the signal may be broadcast to attendant receivers that are assigned to specific gaming machines. This will provide faster and more efficient assistance to players and thereby increase player satisfaction. Furthermore, the faster attendant service is provided, the more game play time the player will have, thereby increasing revenue.

The endpoint 124n may be programmed to filter the data received from the gaming machine 122n as desired or requested. For example, should the casino only request the number of players that played that specific gaming machine 122n over a specific time interval, the endpoint 124n may filter out all other information and transmit only the requested information. Additionally, the endpoint 124n may have the ability to filter out gaming machine data signals from attendant signals to allow the attendant signals to be transmitted to the concentrator 150 immediately.

A fault tolerant system may be implemented to overcome any faults or errors in transmission. For example, should the data transmission from the concentrator 150 to the remote collection server 304 not be possible on the cellular modem 306, the concentrator 150 may switch to the analog modem 308 to transmit the data to the collection server 304. Alternatively, the concentrator 150 may utilize any other means to transmit the data such as digital subscriber line (“DSL”), dial-up, an alternative cellular back-up network, or the like.

Fault tolerant redundant systems may also be implemented by utilizing a plurality of devices to reroute the data communications to auxiliary devices. For example, referring to FIG. 1, if endpoint 104 is unable to transmit the data to concentrator 152, endpoint 104 may transmit the data to another endpoint such as endpoints 124a or 124b that may then transmit the data to concentrator 150. A fault tolerant system comprising redundant devices and data paths allows for the ability to redirect the data to mitigate communication failures.

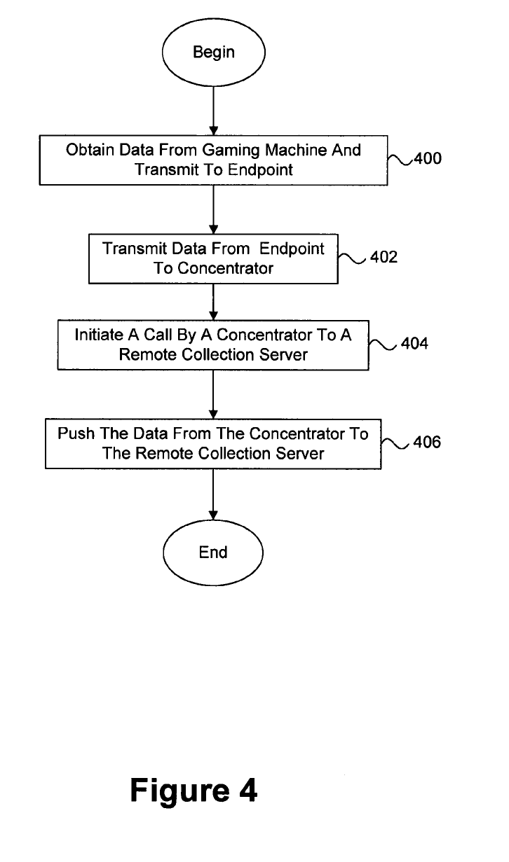

FIG. 4 is a flow diagram illustrating a method to automatically collect data. Data may be sent from the gaming machine to the endpoint at 400. The endpoint may be used to retrieve and collect data from the gaming machine, such as meter data, player tracking data, license usage data and any other data requested by a user. An endpoint may be coupled to each individual gaming machine or one endpoint may be used in a carousel of gaming machines. The endpoint may be installed within a specific gaming machine or may be a remote endpoint device near the carousel.

The data collected from the endpoints may be used for a variety of purposes such as product marketing, theme response, revenue analysis, etc., as described elsewhere herein.

The endpoints may collect the data from the gaming machines at predetermined time intervals, when a timer determines that a predetermined time has been reached for collecting data from the gaming machines and/or for transmitting the data to the concentrator. Alternatively, or additionally, the endpoints may collect or transmit such information upon demand.

In some implementations, the endpoint and/or the gaming machines may be programmed to not interrupt or to slow game play on the gaming machine. Accordingly, before data are collected and/or transmitted, there may be a step of determining whether game play would be interrupted or otherwise degraded by the collection and/or transmission process. The processor may have a filter to enable the queries of the gaming machine meters and disable all other messages, in particular, transmission of commands to the game which could affect game operation or settings. Thus, data may be collected without interrupting or adversely affecting game play on the gaming machine.

The data may be transmitted from the endpoint to a concentrator via a personal area network at 402 using any known protocols such as SAS, G2S, or the like. A synchronizer may synchronize the alarm on the endpoint with the time on the synchronizer to coordinate the push of data. Prior to being transmitted, the data signals may be encrypted by any known means such as advanced encryption standard (AES), data encryption standard (DES), secure shell (SSH), secure socket layer (SSL), transport layer security (TLS), or the like.

The concentrator may initiate a call to a remote collection server at 404 to push the data from the concentrator to the remote collection sever at 406. This may be achieved at brief predefined intervals set by the user or otherwise, e.g., as described elsewhere herein.

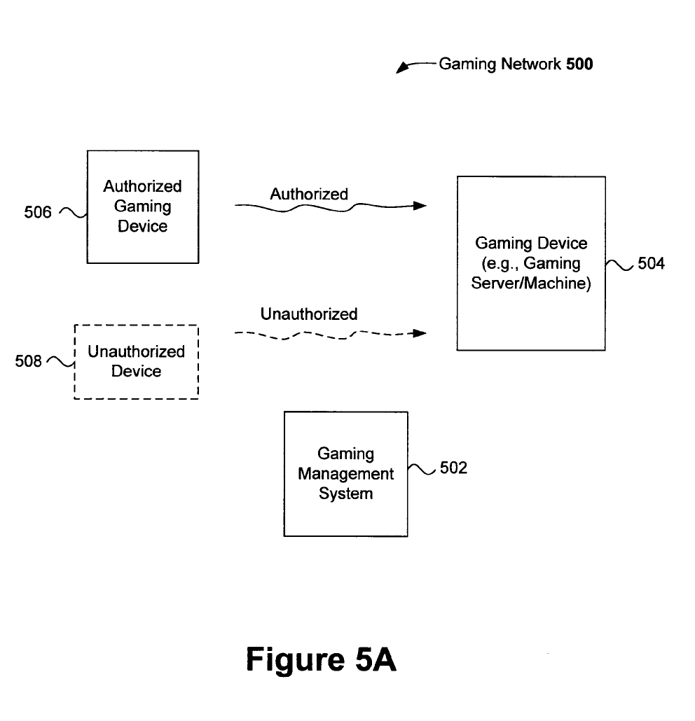

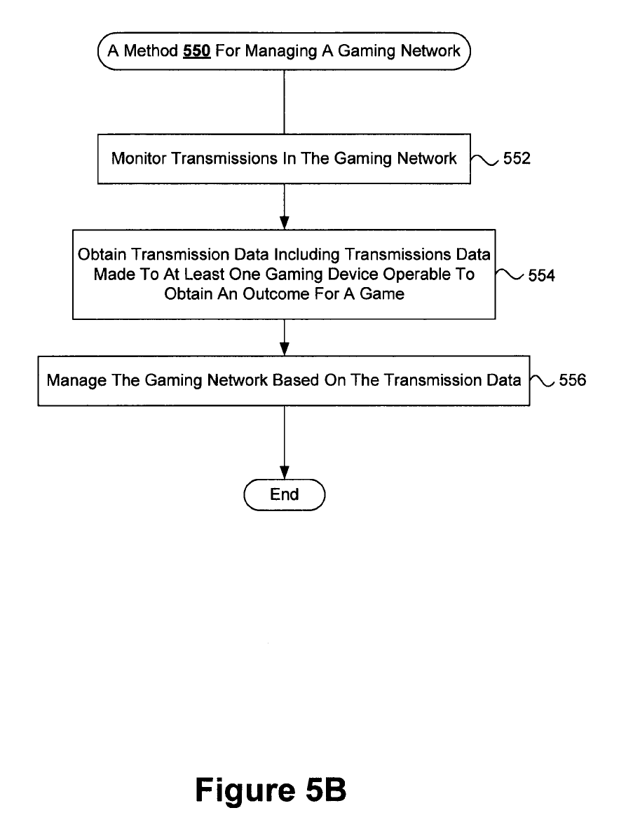

FIG. 5A depicts a gaming management system 502 in a gaming network 500 in accordance with one embodiment of the invention. Referring to FIG. 5A, the gaming management system 500 can effectively manage the gaming network 500. Those skilled in the art will readily appreciate that the gaming network 502 can be a wired and/or wireless gaming network, and as such, can include various components (e.g., gaming machines, gaming servers, routers, wireless gaming devices) which are not shown in FIG. 5A. Generally, the gaming network 500 includes at least one gaming device 504 (e.g., a gaming server, a gaming machine) that is operable to obtain (e.g., determine, receive, or the like) an outcome of a game (e.g., a game of chance, a wagering game, a wagering game of chance, or the like). Typically, the game is managed by a gaming entity (e.g., a casino) that owns and/or operates that gaming device 504. The gaming device 504 may be operable to receive wireless transmissions from a device 506. In other words, the gaming network 500 may be a wireless gaming network with at least one gaming device configured to operate as a wireless device.

As a wireless device, the gaming device 504 can be configured and/or authorized to communicate with the gaming device 504. By way of example, the device 504 can be a wireless device configured to communicate with the gaming device 502 in order to allow a person to play a game on a display provided by the wireless device.

It will be appreciated that the gaming management system 502 can be operable to monitor the gaming network 500 for transmissions including the transmissions to and from the gaming device 504. In other words, the gaming management system 502 can be operable to monitor data transmitted and received by the gaming device 504. By monitoring the gaming network 500, the gaming management system 502 can obtain data (transmission data) pertaining to transmissions made in the gaming network 500. It will be appreciated that the transmission data effectively collected by the gaming management system 502 can include content of data transmitted and one or more attributes regarding the transmissions (e.g., signal strength, location of transmission). It will also be appreciated that the management system 502 can use the collected transmission data to effectively manage the gaming network 500.

Management activities performed by the management system 502 can, for example, include securing the gaming network 500 against unauthorized access and/or one or more unauthorized devices 508, changing the mode and/or manner of communication (e.g., changing the communication channel) between the gaming device 504 and one or more other authorized devices 506, and generating and providing alerts regarding the gaming network 500 (e.g., sending alerts to a network administrator regarding any possible breach of security of the gaming network 500). The management system 502 can be operable to determine, based on the content of data transmitted and/or one or more attributes of transmission, whether an attempt has been made to breach the security of the gaming network 500 and/or whether the security of the wireless gaming network has been breached. The attributes of transmission that may be considered by the management system 502 may, for example, include: one or more attributes associated with signal transmission, one or more attributes associated with signal transmission of a wireless transmission, strength of signal transmission, strength of wireless signal transmission, channel of transmission, channel of wireless signal transmission, one or more attributes associated with transmitted content, one or more attributes associated with content transmitted wirelessly, encryption keys used to encrypt said transmitted content, rate of data transfer, originating location of transmission, proximity of transmission, and one or more identifiers associated with one or more devices transmitting said wireless transmission.

FIG. 5B depicts a method 550 for managing a gaming network in accordance with one embodiment of the invention. Referring to FIG. 5B, initially, the transmissions in the gaming network are monitored (552). Next, transmission data is obtained (554) from the transmissions in the gaming network. The gaming network includes at least one gaming device operable to generate or obtain an outcome for a game that can be played in the gaming network. As such, the transmission data can include at least transmission data pertaining to transmissions made to the gaming device. Referring back to FIG. 5B, the gaming network is managed based on the transmission data obtained (556).

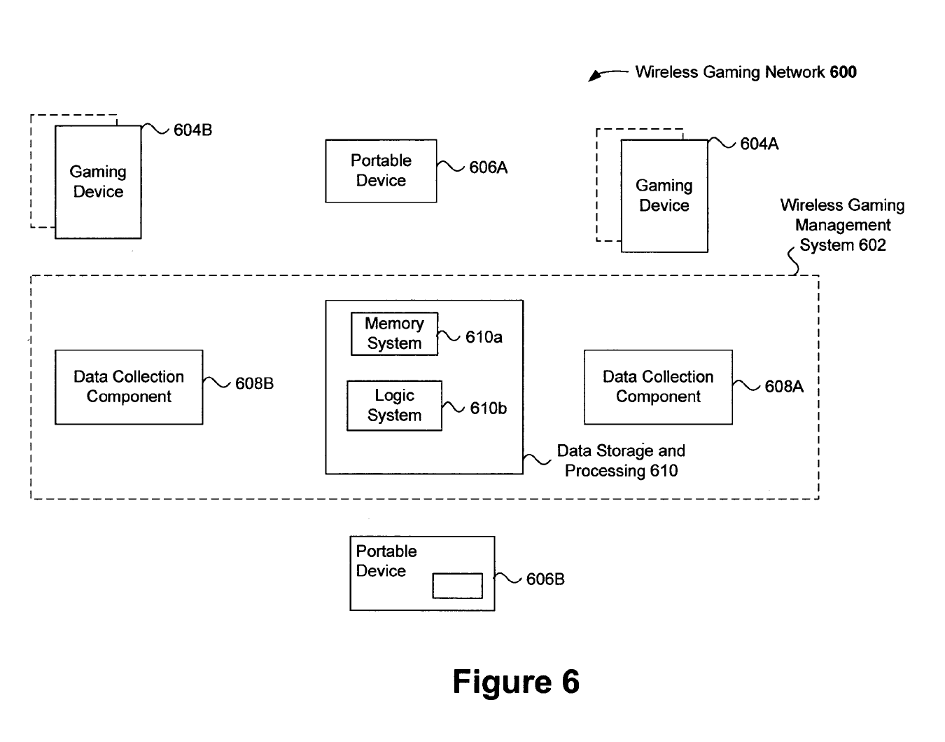

Wireless networking is a relatively new development and may be preferred over wired networks for some applications. As such, a wireless gaming network 600 will now be described in greater detail with reference to FIG. 6. Wireless gaming management system 602 can effectively manage the wireless gaming network 600. The wireless gaming network 600 can include one or more gaming devices (here, gaming devices 604A and 604B) and portable devices (here, portable devices 606A and 606B). The gaming devices may, for example, be operable to receive wireless transmissions from one or more of the portable devices.

Referring back to FIG. 6, the wireless gaming management system 602 may include one or more data collection components, such as data collection components 608A and 608B, and one or more data storage and processing components 610. In general, a data collection component may be operable to monitor transmissions made in the wireless gaming network 600. Each of the data collection components 608A and 608B, for example, may be configured to monitor transmissions made to the one or more gaming devices (e.g., to gaming devices 604A and 604B), obtain data, and effectively provide the data to one or more designated storage and processing components 610. For example, the data collection component 608A can be operable to monitor data transmissions made to the gaming device 604A and the data collection component 608B can be operable to monitor data transmissions made to the gaming device 604B.

It will be appreciated that the number and configuration of components depicted in FIG. 6 are set forth merely to provide a simple example for this discussion. In practice, for example, more than two gaming devices will be included in wireless network 600. Moreover, wireless network 600 may include more than two portable devices. In addition, the components may be configured in a one-to-one, a many-to-one or a one-to-many configuration. For example, a data collection component may be operable to monitor data transmissions made by one gaming device or by more than one gaming device.

It will be appreciated that a data collection component can be operable to obtain data regarding wireless transmissions without interfering with the operations of the gaming devices. By way of example, the data collection component 608A can include an endpoint component (e.g., a ZigBee endpoint) operable to monitor wireless transmissions to the one or more gaming devices 604A and operable to not interfere with various other gaming operations of the one or more other gaming devices (including but not limited to gaming device 604B), including but not limited to operations relating to generating or obtaining the outcome of a game. In accordance with one embodiment of the invention, the data collection components 608A and/or 608B may include a ZIgBee endpoint device.

The data storage and processing component 610 may obtain data from data collection components 608A and/or 608B and store at least some of the data in a memory system 610a, which may include one or more types of memory devices known in the art. As shown in FIG. 6, the storage and data processing component 610 can also include logic system 610b, which may comprise one or more processors, programmable logic devices or other logic devices. Logic system 610b may be operable to process the data stored in the storage 610a in order to manage the wireless gaming network 600. It will be appreciated that the storage and data processing component 610 can be operable to store and process data obtained by a data collection component without interfering with game play operations (or other functionality) on the gaming devices.

The storage and data processing component 610 may include a data concentrator configured to receive data from one or more data collection components. By way of example, the data concentrator may be a ZigBee coordinator (or concentrator) operable to receive transmission data from one or more ZigBee endpoints. Those skilled in the art will readily know that a ZigBee coordinator can be operable to effectively initiate and/or control a wireless gaming network that includes one or more ZigBee endpoints and routers. A ZigBee coordinator can be further operable to perform one or more of the following: store information regarding wireless gaming management system, store information regarding the wireless gaming network, receive, store and process data collected by a ZigBee endpoint, send the collected data to one or more logic devices for processing, provide access to collected data, and allow one or more logic devices to access said collected data.

It should be noted that a ZigBee coordinator (or concentrator) can be operable to send (e.g., push) the data to another component for processing (e.g., to a server). In other words, the logic system 610b may, for example, include a ZigBee coordinator and/or a server provided for processing the data stored in the memory system 610a. A processing component (e.g., a server) can be operable to process the data in order to effectively manage the wireless gaming network 500. It should be noted that a coordinator component of data storage and processing component 610 may be operable to perform the processing, but it may be easier and/or more practical for some applications if the processing is performed by a server.

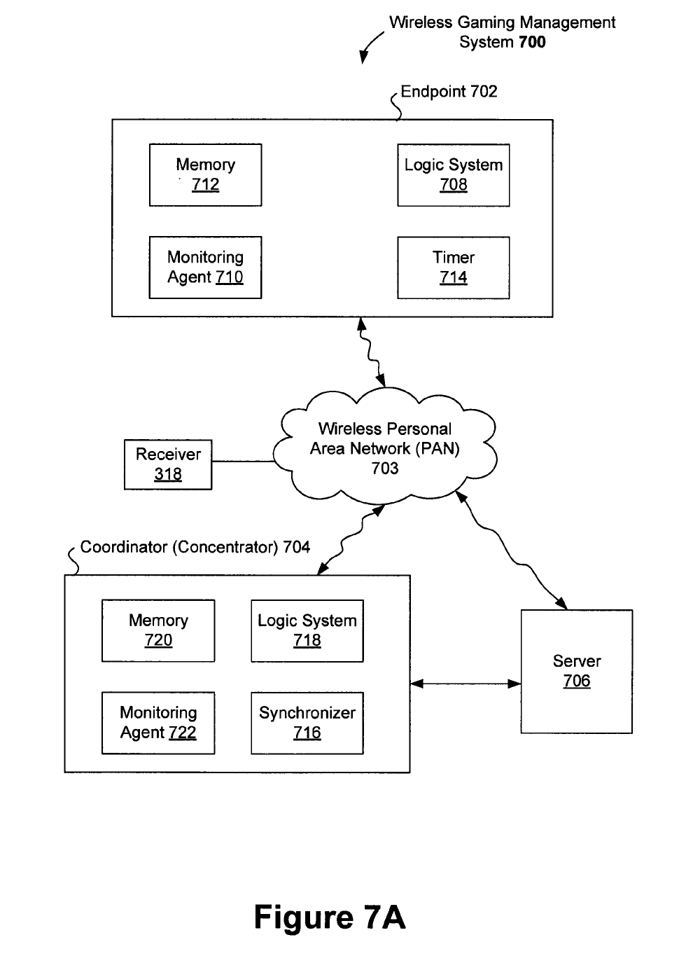

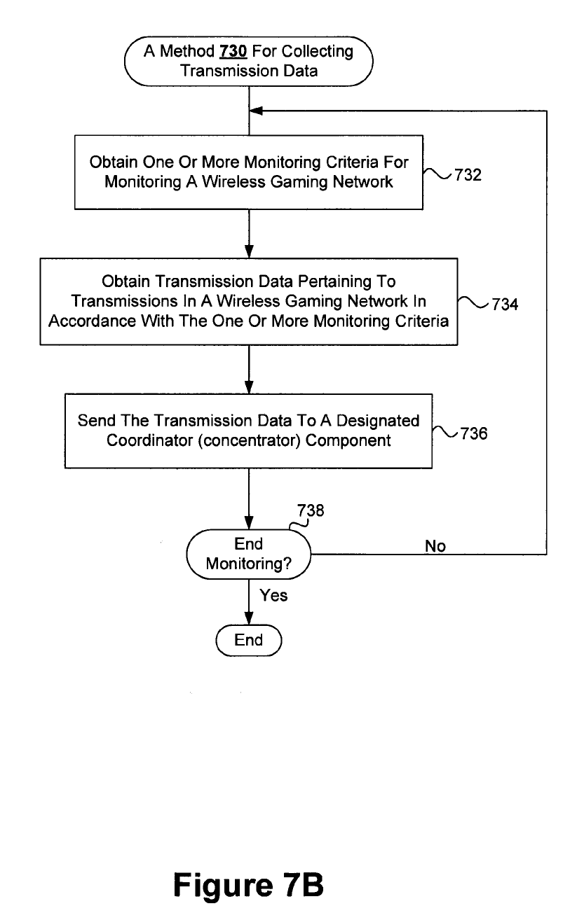

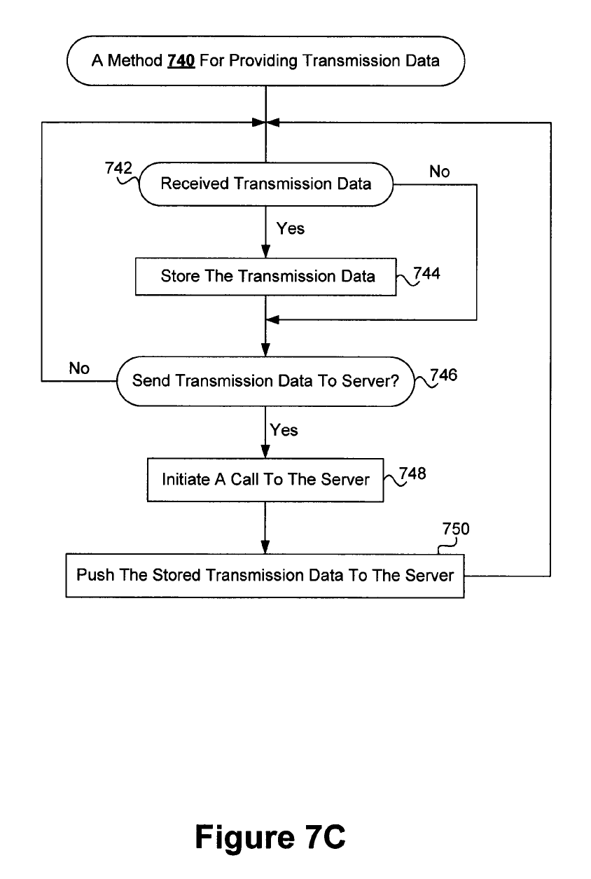

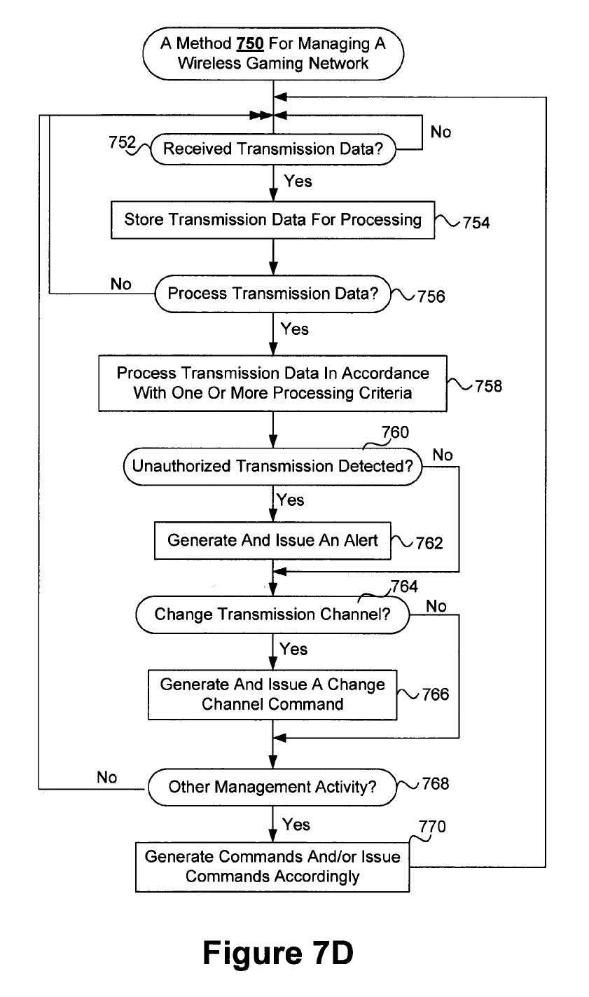

To further elaborate, FIG. 7A depicts a wireless gaming management system 700 in accordance with another embodiment of the invention. Referring to FIG. 7A, the wireless gaming management system 700 includes an endpoint component 702, a coordinator component 704, and a server 706. The endpoint component 702 may be communicatively coupled to the concentrator component 704 via a wireless personal area network (WPAN) 703 using various communication protocols including SAS, G2S, and/or others required to interoperate with the industry-standard communication protocols prescribed by the Gaming Standards Association. The wireless PAN 206 may be configured for communication according to any known network standard, but is configured for communication according to ZigBee in this example.

The endpoint component 702 can, for example, be any ZigBee device, such as the XBee™ and XBee-PRO™ ZigBee modules sold by MaxStream of Orem, Utah. The endpoint component 702 may have a logic system 708 operable to receive and process the data signals from the concentrator component 704. The logic system 708 may comprise one or more processors or other logic device(s) configured to monitor wireless transmissions. In some implementations, logic system 708 will not transmit commands to the gaming devices that could affect game operation or settings. Thus, data may be collected without interrupting or affecting the game play on the gaming machine. The endpoint component 702 may have a memory 712 to store transmission data. In some implementations, data may be pushed to the concentrator 152 when timer 714 determines that a predetermined time for a data push has arrived. The timer 714 may be synchronized with a synchronizer 716 of the coordinator component 704.

A monitoring agent 710 can be operable to “sweep” between various channels and detect unauthorized transmission based on various attributes of transmission, such as, for example, signal strength. The monitoring agent 710 can also be operable to examine and verify that the encryption settings of the content transmitted are correct, to ensure that the transmission is authorized. By way of example, encrypted content can be decrypted using encryption keys (e.g., an AES key) to ensure that various headers conform to an expected form. In addition, monitoring agent 710 may monitor the payload and cause the communication channel to be changed if necessary or desirable. The monitoring agent 710 can communicate with the coordinator component (704) to determine which channel is being used and analyze the channel for various criteria related to outage potential, noise and/or bandwidth limitations. The monitoring agent 710 may also analyze free unassigned communication channels and determine whether a channel change is necessary to increase transmission reliability. If signal quality on the channel being used falls below a predefined threshold such that a channel change is necessary, the monitoring agent 710 may send a signal to the concentrator coordinator 704 to effectively indicate that a different communication channel should be used. Additionally, the monitoring agent 710 may continuously monitor the communication channels to pre-select a communication channel for any new device that may be used within the ZigBee network.

The concentrator component 704 may include various components or devices, including those providing communication, networking, processing, and memory. The concentrator component 704 may have a logic system 718 for processing data and signals received from the endpoint component 702 via the WPAN 703. The synchronizer 716 may be used to synchronize the alarm 714 of the endpoint component 702. As noted above, an endpoint component may collect data at predetermined time intervals such as once a day or several times a day. Alternatively, an endpoint may collect data when an internal alarm is triggered. The time intervals at which endpoint components communicate with the concentrator components may be intentionally varied or randomized in order to increase system security. Alternatively, or additionally, data may be collected on demand, e.g., in response to a request from a device operated by a casino administrator.

The coordinator component 704 can be operable to effectively provide the data to a server 706 for processing. By way of example, the coordinator component 704 may initiate a call to the server 706 and effectively push the data to the server 706. The server 706 can be operable to store the data and analyze the data in order to effectively manage a wireless gaming network. The server 706 may communicate with a monitoring agent 722 of the coordinator component 704 in order to perform various management tasks including issuing alerts regarding potential unauthorized transmissions to one or more one attendant receivers 318, requesting transmission channel to be changed.

FIG. 7B depicts a method 730 for collecting transmission data in accordance with one embodiment of the invention. It will be appreciated that the transmission data can be used to monitor a wireless gaming network in accordance with the invention. Method 730 can, for example, be used by the endpoint component 702 depicted in FIG. 7A. The steps of method 730, like those of other methods shown and described herein, are not necessarily performed in the order indicated. Moreover, such methods (and/or related methods) may include more or fewer steps than are indicated.

Referring to FIG. 7B, initially one or more monitoring criteria for monitoring a wireless gaming network are obtained (step 732). Next, transmission data pertaining to transmission in the wireless gaming network are obtained (step 734) in accordance with one or more monitoring criteria. A monitoring criterion can, for example, be defined so that every transmission made in the wireless gaming network is obtained. As another example, a more specific monitoring criterion can be defined to collect specific data pertaining to one or more attributes of transmissions made in the wireless gaming network (e.g., strength of the signals of one or more channels can be determined). Referring back to FIG. 7B, after obtaining the transmission data, the transmission data is sent to a coordinator (concentrator) component (736). In effect, the method 730 can obtain transmission data (734) in accordance with one or more monitoring criteria and send the transmission data to a designated coordinator (736) unless it is determined (738) to end monitoring the wireless gaming network. The method 730 ends when it is determined (738) to end monitoring the wireless gaming network.

FIG. 7C depicts a method 740 for providing transmission data in accordance with one embodiment of the invention. The transmission data is suitable for management of a wireless gaming network in accordance with the invention. The method 740 can, for example, be used by a coordinator component 704 depicted in FIG. 7A. Referring to FIG. 7C, it is determined (742) whether transmission data has been received. The transmission data can, for example, be sent by an endpoint component 702 depicted in FIG. 7A. If it is determined (742) that transmission data has been received, the transmission data can be stored (744). Subsequently, it can be determined (746) whether to send the transmission data to a server designated for processing the transmission data. Accordingly, a call to the server can be initiated (748) and the transmission data can be effectively pushed to the server (750). In effect, the method 740 can wait to receive transmission data and push it to the server. As noted above, transmission data can be pushed to the server at designated times and/or where it may be more feasible to do so.

FIG. 7D depicts a method 750 for managing a wireless gaming network in accordance with one embodiment of the invention. The method 750 can, for example, be performed by the server 706 depicted in FIG. 7A. Referring to FIG. 7D, initially, it is determined whether transmission data is received. If it is determined (752) the transmission data has been received, the transmission data can be stored (754) for processing. Next, it can be determined (756) whether to process the transmission data. Data can, for example, be processed as soon as it is received or at designated time intervals. Referring back to FIG. 7D, transmission data can be process in accordance with one or more processing criteria (758). By way of example, a processing criterion can effectively be defined to process the content of transmissions made and/or various attributes of the transmission can be considered. In general, various management activities can be performed.

FIG. 7D depicts a few exemplary management activities. Referring to FIG. 7D, it can be determined based on one or more processing criteria whether an authorized transmission has been detected (760) and an alert can be generated and issued accordingly (762). As another example, it can be determined (764) whether to change the transmission channel and a command to effectively change the transmission channel can be generated and issued (766). In addition, it can be determined (768) whether to perform other management activities and as a result one or more other management commands can be generated and issued accordingly (770). In effect, the method 750 can wait to receive data and process the data in order to perform various transmission activities.

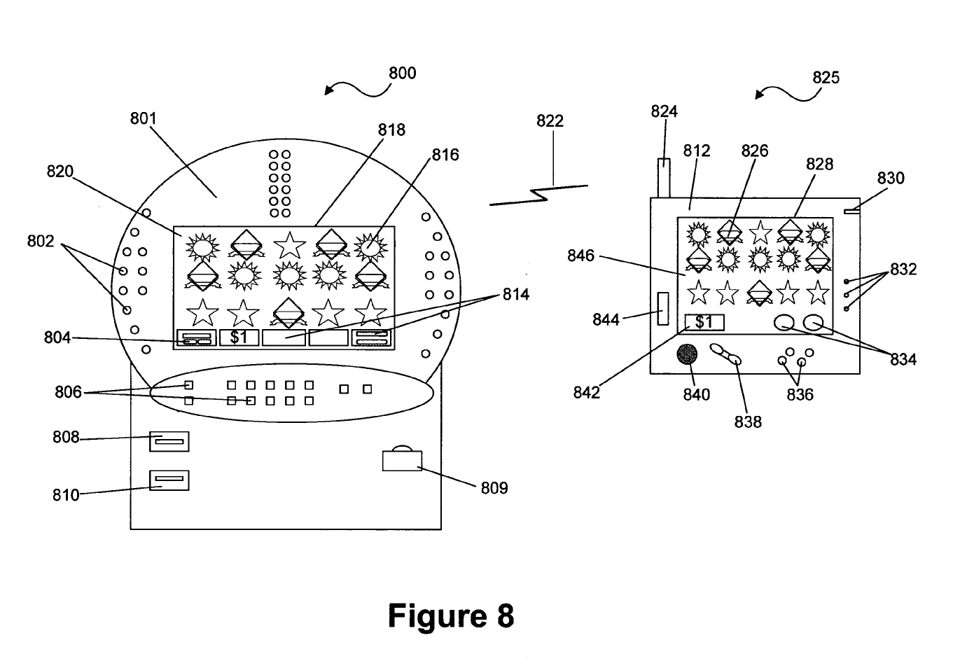

It should be noted that a wireless gaming device can be used to play a game in a gaming environment that uses the authentication techniques of the invention. FIG. 8 is block diagram of a gaming machine 800 in communication with a wireless game player 825. The wireless game player 825 is used as a remote extension to extend the game playing capabilities of gaming machine 800. Game outcomes for games of chance generated using licensed and regulated gaming software executed on the gaming machine 800 may be presented on the wireless game player 825 at remote locations from the gaming machine 800. Thus, a game generated on a gaming machine 800 may be presented on a display 818 located on the main cabinet 801 of the gaming machine and played using input mechanisms located on the main cabinet of the gaming machine. In addition, the game generated on the gaming machine may be presented on a display 828 located on a wireless game player in communication with the gaming machine and played with input mechanisms located on the wireless game player.

As an example, a game 816 may be presented on a display 818 located on gaming machine 800. The game 816 may be played using input mechanisms, such as input buttons 806 or touch screen interface buttons 804. The touch screen interface buttons 804 are activated using a touch screen 820 located over the display 818 of the gaming machine 800. Further, a game 826 may be presented on display 828 located on the wireless game player 825. The game 826 may be played using input mechanisms located on the wireless game player 825, such as 838 and 836 or touch screen interface buttons 834. The touch screen interface buttons 834 are activated using the touch screen 846 located over the display 828.

The game logic for a game presented on display 818 or display 828 is stored within the main cabinet 801 of the gaming machine 800. The game logic, which is typically regulated gaming software, is executed by a master gaming controller located within the main cabinet 801 of the gaming machine 800. A particular game executed by the master gaming controller may be presented on display 818 or, when the wireless game player 825 is activated, on display 828. When the same game is presented on display 818 or on display 828, the graphical presentations of the game may vary between the displays because of hardware differences. For instance, display 818 may by larger than display 828 allowing for higher resolution graphical output on display 818 as compared to display 828.

While playing a game 826 on the portable wireless game player 825, a player may move throughout the areas of a casino where wireless game play is enabled. For instance, a player may be able to play the game 826 with the wireless game player 825 in a restaurant, a keno parlor or a sports book. The player's position does not have to remain static while playing the game 826 on the wireless game player 825 and the player may be actively moving while games are played on the wireless game player 825.

When a game is played on the wireless game player of the present invention, such as 825, all random number generation (RNG) events, game outcomes, meter information, game related information, and all cash transactions are generated or obtained and maintained in the licensed (controlled) gaming machine (e.g. 800), and not the wireless game device. Thus, the wireless game player 825 may be considered a remote extension of the gaming machine's 800 display and input mechanisms. With a gaming machine with a remote extension, the gaming machine may operate in both a local mode and a remote mode. In the local operational mode, game play is presented using the display and input mechanisms located on the gaming machine. In the remote operational model, game play is presented using the display and input mechanisms located on the wireless game player. These two operational modes are described as follows.

During local game play on a gaming machine, a player may input money or indicia of credit into the gaming machine, indicate a wager amount, and initiate a game play. For example, to play the slot game 816 on gaming machine 800, a player may deposit money or indicia of credit using the bill validator 808, the card reader 810 or the coin acceptor 809. Status information 814 for the game, such as a game denomination and available credits may be displayed on display 818. Next, using input buttons 806 and touch screen interface buttons 804, the player may make a wager and initiate the game. The gaming machine obtains or determines a game outcome and then presents the game outcome to player on the display 818. For instance, after a slot game has been initiated, the video gaming machine calculates the final position of the reels (e.g. the game outcome), the reels on display 818 spin and then stop at pre-determined position. Based on the pre-determined outcome obtained or calculated by the master gaming controller, an award may be presented to the player. As another example, after a card game has been initiated, the video gaming machine 800 calculates a sequence of cards to be dealt to the player and card hands are dealt on the display 818. During the card game play, the player may use input mechanisms on the gaming machine 800 to hold or discard cards. After the card game is complete, an award may be presented to the game player.

The games presented on the gaming machine 800 may be enhanced by additional features. Light patterns, such as from lights 802, and sounds may be generated on the gaming machine 800 to enhance the game outcome presentation. In addition, during certain game events, a bonus game may be presented to the game player.

During remote game play on a gaming machine using a wireless game player such as 825, a player may input money or indicia of credit into the gaming machine, activate a wireless game player, indicate a wager amount on the wireless game player and initiate a game play on the wireless game player. For example, to play the slot game 826 on gaming machine 800 using the wireless game player 825, a wireless game play session is requested by the player. A wireless game play session may include one or more game plays on a wireless game player 825 connected to the gaming machine 800 via a wireless communication link 822. The wireless game play session request by the player may be made using an input mechanisms located on the gaming machine.

Prior to beginning the wireless game play session, a player may be required to deposit money or indicia of credit to in the gaming machine in communication with the wireless game player. The deposited credits may be used during the wireless game play session. For instance, using the bill validator 808, the card reader 810 or the coin acceptor 809 located on the gaming machine 800, the player may provide an initial amount of credits to be used for a wireless game play session using the wireless game player 825. During game play on the wireless game player, a player wagers a certain amount of credits per game. Depending on the outcome of a particular game, the number of credits available for game play may be decreased or may be increased.

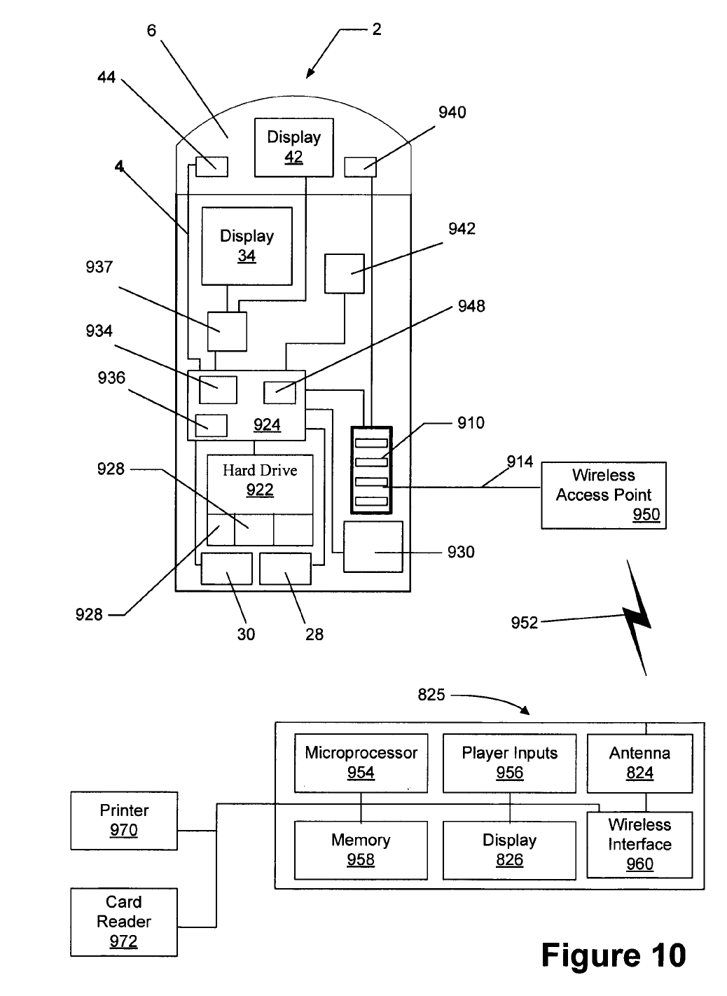

After a game player has used all of their credits during a wireless game play session and the player desires to continue the wireless game play session, the player may be required to return to the gaming machine to add additional credits. In other embodiments (See FIG. 10), a card reader or other input device may be attached to the wireless game player 825 and used to add credits to the gaming machine 800. For instance, a player may be able to enter a credit card number or debit card number and transfer funds to the gaming machine to be used as game credits via a touch screen interface on the wireless game player 825. Further, the wireless game player may include a card reader for scanning a magnetic strip on the debit card or credit card.

After establishing game credits on the gaming machine, the wireless game player 825 is activated. In some embodiments, authentication and verification of the user of the wireless game player is performed. For example, to enforce age restrictions imposed by a jurisdiction, the user may be verified and authenticated to use the game player. The wireless game player may have a biometric sensor (not shown) such as a fingerprint sensor. As part of the authentication process, the player may be asked to place their finger on the sensor located on located on the wireless game player. The fingerprint image is sent back to the controller in the machine for comparison. As another example, the wireless game player may include a smart-card reader that reads biometric smart cards (cards having a built-in fingerprint sensor). The smart card has all the personal information of the casino guest. Thus, the authentication could occur directly at the wireless game player. A description of a finger print reader as an identification device is provided in U.S. Pat. No. 6,488,585, which is incorporated herein in its entirety and for all purposes. Other types of verification methods such as a PIN number or a password may be used separately or in combination with biometric identification methods. Other biometric identification methods that may be used with the present invention include but are not limited to feature identification using a camera, retinal pattern identification using a retinal scanner, voice pattern identification input using a microphone and hand-writing recognition using a hand writing input pad.

For security, the wireless game player has an encrypted serial number (code), which is used to verify and authenticate the wireless game player. For additional security, an electronic key may be used with the device. With an electronic key system, the wireless game player device cannot be activated until the key is inserted into a receptacle on the game player. In addition, the wireless game player may have a small GPS (Global Positioning System) device or other location determination device or system to verify location of the device. Position verification may be used to insure the wireless game player is used only in legal gaming areas of the casino and to track lost or stolen devices. When the gaming machine detects that the wireless game player is in a restricted area, it may discontinue communications with the wireless game player. Further, the wireless game player may have an RF capacitive device built into the wireless game player. RF capacitive devices are often used in retail stores to prevent theft. When the wireless game player is passed through a protected doorway, an alarm may be sounded even when the power is off to the wireless game player. Other security features may be used on the wireless game player and are not limited to electronic keys, GPS sensors or RF capacitive devices described above. Verification and authentication may be required to start every wireless game play session. Further, there may be a non-play time limit. Once this time is exceeded, a verification and authentication cycle or process must be performed. The verification and authentication cycle may be performed for the player and the wireless game player, for only the player or for only the wireless game player. As another example, authentication and verification may be required after a certain number of games played on the gaming device or may be even be required at random intervals. When verification and authentication requirements are not satisfied during a wireless game play session, the game play session will typically be terminated.

In one embodiment, after the wireless game player is activated 825, the input mechanisms, such as the touch screen 820 and the input buttons 806, built into the gaming machine 800 are deactivated and a wireless game play session may begin. The display 818 on the gaming machine 801 may display an “out of order” message, an “operator” message or the display 818 may be blank to indicate the gaming machine is unavailable for game play. During remote game play on the wireless game player 825, gaming information necessary to present the game on the wireless game player, such as a graphical presentation of game outcome and meter information, is generated on the gaming machine 800 are transmitted to the wireless game player via wireless communication 822. The mathematical methods used to generate the game outcomes remain on the gaming machine 800 or on a remote gaming device or outcome server operatively coupled to the gaming machine via a wired or wireless connection, including but not limited to a computer network connection using any suitable communication protocol. Further, gaming information required by the gaming machine 800 to the determine the game outcome, such as signals from input mechanisms located on the wireless game player, are transmitted from the wireless game player 825 to the gaming machine 800 via wireless communication 822.

During game play on the wireless game player 825, status information 842 for the game 826, such as a game denomination and available credits may be displayed on display 828. The status information 842 and the game 826 displayed on the wireless game player 825 may appear similar to what is displayed on the gaming machine 801 but is not necessarily identical to what is displayed on the gaming machine 800. Next, using input buttons, such 834, 836 and 838, the player may make a wager and initiate the game. In one embodiment of the present invention, the touch screen interface buttons 834 may be based on a web-browser interface.

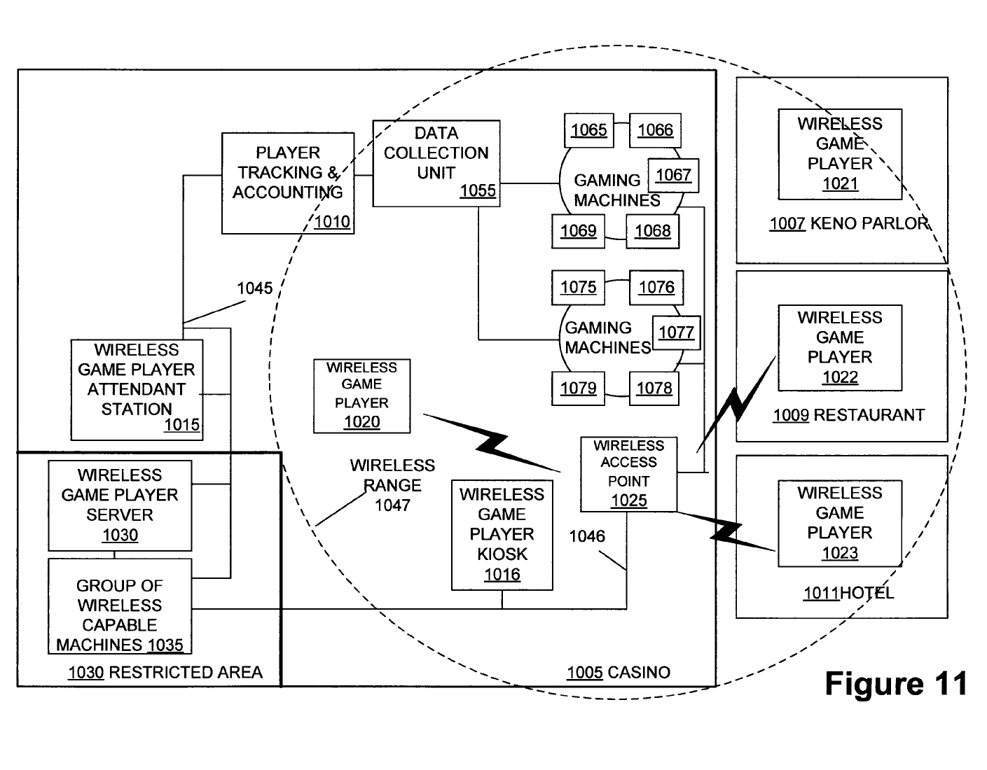

After a game has been initiated on the wireless game player 825, via antenna 824, a wireless communication 822 containing the wager and initiate game inputs is sent to the gaming machine 800. In response, to the wager and the initialization of a game, the gaming machine 800 generates a game outcome including an award and possibly a bonus game. Instructions for displaying the game outcome and bonus game are sent in one or more wireless communications 822 to the wireless game player 825. The one or more wireless communications may be a series of information packets. The format of the information packets will vary according to the wireless communication standard used. Details of a wireless network for providing wireless communications is described with respect to FIG. 11. To illustrate the play of a particular game, a slot game and a card game are described. However, the present invention is not limited to these games as nearly any type of game that can be played on a video gaming machine may also be played on the wireless game player 825. When a slot game 826 has been initiated on the wireless game player 825, the gaming machine 800 calculates or obtains the final position of the reels (e.g., the game outcome). The gaming machine may send instruction to the wireless game player to spin the reels on display 828 and then stop the reels at the position corresponding to the pre-determined game outcome. Based on the final position of the reels calculated by the master gaming controller located on gaming machine 800, an award may be presented to the player. In addition, during certain game events, a bonus game may be presented to the game player as part of the slot game. As another example, after a card game has been initiated on the wireless game player 825, the video gaming machine 800 calculates or obtains a sequence of cards to be dealt. The gaming machine 800 sends wireless communications 822 to the wireless game player 825 indicating card hands to be dealt on the display 828. During the card game play, the player may use input mechanisms on the wireless game player 825 to hold or discard cards. After the card game is complete, an award may be presented to the game player. A bonus game may also be incorporated into the card game.

When a customer does not wish to use the wireless game player 825 anymore, the customer can terminate the wireless game play session using the touch screen 846 and deactivate the wireless game player 825. As described above, the wireless game player 825 may automatically terminate a wireless game play session and deactivate itself after a period of inactivity. After roaming with the wireless game player 825, the customer may return to the gaming machine providing the wireless game play session and wish to resume play on the main display of the gaming machine. In this case, the customer may depress a “return” button on the wireless game player 825 and after a verification cycle the player can begin playing at the gaming machine again.

The games presented on the wireless game player 825 may be enhanced by additional features. For instance, light patterns and sounds from the audio output 840 may be generated to enhance the game outcome presentation and add excitement to the games played on the wireless game player 825. Further, the wireless game player may include an audio output interface for connecting headphones. As part of a game outcome presentation, sounds may be transmitted through the audio output interface to headphones worn by the game player.

Details of the wireless game player hardware are now described. The wireless game player 825 is generally a hand-held device. It consists of a housing 812, display 828, touch screen 846, switch panel 844, battery, wireless communication interface, and controller. In one embodiment of the present invention, a modified DT Research WebDT pad (DT Research, Inc., Milpitas, Calif.) is used as a wireless game player. However, the present invention is not limited to the DT research WebDT pad as other hand-held wireless devices such as personal digital assistants (PDA) may also be used.

In one embodiment, the wireless game player may be approximately 10.5×9.5×1.0 inches in size, weigh 3 pounds and use a 10.4 inch color LCD touch screen display. Typically, an 8 inch to 10.4 inch display provides a sufficient viewing area without reducing the size of the character fonts to a point where they are unreadable by most players. The touch screen (sensor) 846 is overlaid on the displayable surface of the LCD 828. Other display technologies can be used instead of LCD, plus some display technologies will incorporate a built-in touch screen (internal vs. external). To activate the touch screen 846, a stylus 830 may be used, but most people will use their fingers.

Audio is available via the small built-in speaker 840 or an external headset. Lighting schemes, such as arrays of LEDs, may be added to the wireless game player 825 to provide visual effects and to communicate status information to a game player. Status information, such as a battery level and connection status, may be provided by the status lights 832. The layout and number of the input buttons, including 838 and 836, is variable. In FIG. 8, the configuration of the input buttons on the gaming machine 800 and wireless game player are different. In one embodiment of the present invention, the input buttons on the wireless game player 825 may be configured in a manner similar to input buttons located on the gaming machine. Further, other devices on the wireless game player, such as the audio output 840, the status lights 832, the antenna 824 and the on/off switch 844 may be located at other locations on the housing 812 depending on the design of the wireless game player.

In one embodiment, the battery will last 5 hours between charging. Charging of the wireless game player may be accomplished by setting the wireless game player in a special storage cradle. The cradles may be in the form of storage bins located in a special area, located at the gaming machine or built as holders located on a desk, counter or table. For instance, a storage cradle for charging the wireless game player may be located in a keno parlor, restaurant tables or sports book. When the wireless game player is placed in a storage cradle it may used while being charged.

The wireless game player 825 can, for example, use an IEEE 802.11b compliant wireless interface. It is a 2.4 Ghz Direct Sequence Spread Spectrum radio system. It has a range of up to 330 ft (inside) from any access point. The data rate is 11 Mbps. IEEE 802.11b is a commonly used radio standard. Other exemplary wireless standards that may be used include IEEE 802.11a, IEEE 802.11g, IEEE 802.11n, IEEE 802.11x, hyperlan/2, Bluetooth, IrDA, and HomeRF.

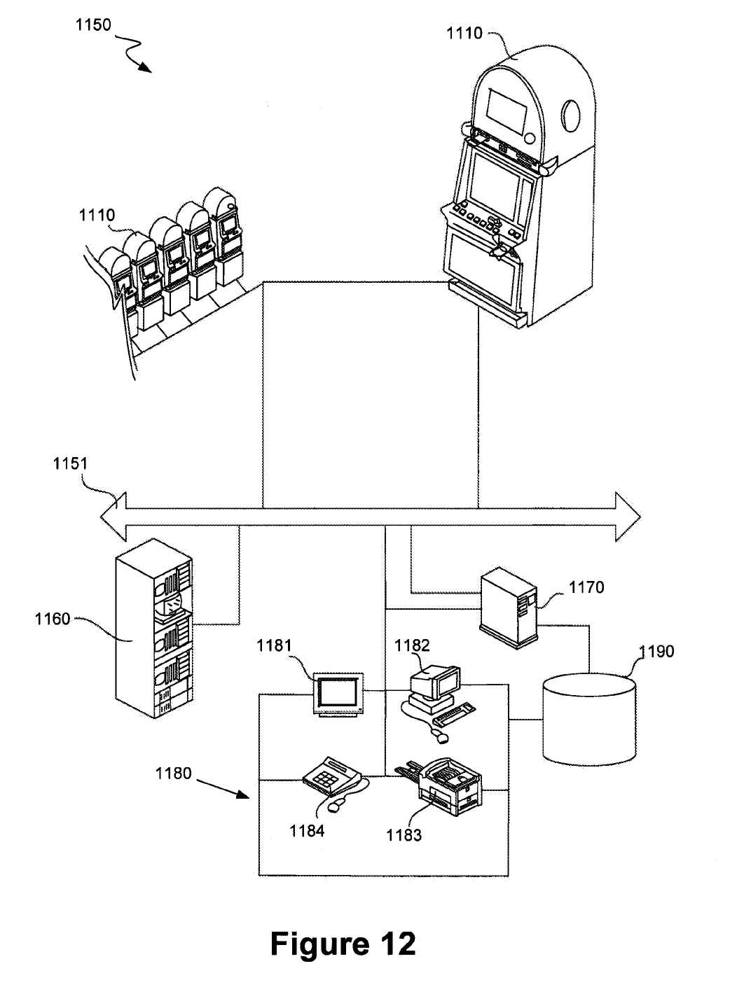

In the example above, local gaming and remote gaming on gaming machine 800 has been described in a mutually exclusive manner. Therefore, when local gaming is enabled, remote gaming is disabled and when remote gaming is enabled, local gaming is disabled. However, the present invention is not so limited. Gaming machines that support only remote gaming and not local gaming may be used with the present invention. These gaming machines (see FIG. 12) may be located away from the casino floor. Further, a gaming machine may support simultaneously a plurality of remote gaming devices for game play and not just a single remote gaming device. Finally, gaming machine may be used that simultaneously provide both remote game play and local game play. For instance, one game player may use a gaming machine for local play while another game player is using a wireless game player connected to the gaming machine to play remotely.

In FIG. 9, another video gaming machine 2 suitable for use with the present invention is shown. Referring to FIG. 9, more details of a gaming machine as well as additional gaming services that may be provided with a gaming machine providing remote game play sessions are described. For instance, player tracking services may be provided on gaming machines of the present invention and player tracking points may be accumulated during a wireless game play session. Further, using a player tracking device located on a gaming machine, a player may be able to request a wireless game player for use in a wireless game play session.

Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The main display monitor 34 will typically be a cathode ray tube, high resolution flat-panel LCD, or other conventional electronically controlled video monitor. The gaming machine 2 includes a top box 6, which sits on top of the main cabinet 4. A second display monitor 42 may be provided in the top box. The second display monitor may also be a cathode ray tube, high resolution flat-panel LCD or other conventional electronically controlled video monitor. In addition, the gaming machine 2 is designed to communicate to the wireless game player 825 with display 828. The wireless game player 825 effectively provides a remote extension to gaming machine 2.

Typically, after a player has initiated a game on the gaming machine, one purpose of the main display monitor 34, the second display monitor 42 or the remote display 828 is the visual display of a game outcome presentation, including bonus games, controlled by a master gaming controller 924 (FIG. 10). Also, the main display monitor 34, the second display monitor 42 and the remote display 828 may also be utilized to display entertainment content independent of the game outcome presentation. For example, broadcast events, including television programming, may be provided to the main display monitor 34, the secondary display monitor 42 or the remote display 828. The broadcast events may be sent to the gaming machine 2 via a cable link or other suitable link from outside of the gaming machine. All or some subset of the programming provided by a television broadcaster may be displayed as entertainment content on one or more of the video displays.

Television programming content of particular interest to casino operators and game players may include, for example, sporting events, talk shows, game shows, soap operas, advertisements, situation comedies, etc. In addition, broadcasts of competitive events on which the player can wager may be displayed. For example, dog racing or horse racing events may be displayed as content on the remote display 828. In such events, typically, there is a rather long down time between races. During this period, the player may play the wireless game player 825 connected to the gaming machine. Also, the television programming entertainment content may be displayed while a player is engaged in playing a game on the wireless game player 825 or between games. Similarly, the entertainment content may include information available on the Internet, including the World Wide Web, for more technologically sophisticated players.

Returning to the gaming machine in FIG. 9, the information panel 36 may be a back-lit, silk screened glass panel with lettering to indicate general game information including, for example, the number of coins played. The bill validator 30, player-input switches 32, video display monitor 34, and information panel are devices used to play a game on the game machine 2 including the wireless game player 825. The devices are controlled by a master gaming controller (see FIG. 10), housed inside the main cabinet 4 of the machine 2. Many possible games, including traditional mechanical slot games, video slot games, video poker, video pachinko, multiple hand poker games, video pai-gow poker, video black jack, video keno, video bingo, video roulette, video craps, video card games and general games of chance, may be provided with gaming machines of this invention. These games may be played using the wireless game player 825.

General games of chance refer to games where a player makes a wager on an outcome of the game. The outcome of the game of chance may be affected by one or more decisions may be the player. For instance, in a video card game, the player may hold or discard cards which affect the outcome of the game.

The top box 6 houses a number of devices, which may be used to add features to a game being played on the gaming machine 2, including speakers 10, 12, 14, a ticket printer 18 which may print bar-coded tickets 20, a key pad 22, a fluorescent display 16, a camera 45, microphone 44 and a card reader 24 for entering a magnetic striped cards. The speakers may be used to project sound effects as part of a game outcome presentation. The keypad 22, the fluorescent display 16 and the card reader 24 may be used for to enter and display player tracking information. As another example, the player may enter playing tracking information and identification information using the card reader 24 and the main video display 34 where the main video display may be used as a touch screen to enter information. Player tracking information may be entered into the gaming machine before a player initiates a game on the gaming machine. Typically, the player's incentive to enter player tracking information into the gaming machine 2 is potential rewards related to the amount of a player's game play.

The top box also includes a candle 46. The candle is a light that may be activated by the master gaming controller on the gaming machine. In one embodiment, an antenna (not shown) may be installed in the candle. The antenna may be used to provide wireless game play sessions to one or more wireless game players in communication with the gaming machine 2 via the antenna.

In addition to enabling player tracking services, the key pad 22, the fluorescent display 16 and the card reader 24 may be used to enter identification information that enables a player to access entertainment content or receive personal messages on the gaming machine independent of a game play and game outcome presentation on the gaming machine 2. For example, a player may enter a personal identification number into the gaming machine 2 using the key pad 22 that allows the player to receive entertainment content such as viewing a movie or a broadcast event. As another example, after entering the personal identification number, the player may be allowed to receive a personal message indicating a table is ready at a restaurant in the casino, to receive a personal message containing information on a sporting event such as a score of personal interest to the player utilizing the gaming machine, or to receive other information intended for the player.

In one embodiment of the present invention, the player tracking services and related gaming service described above may be provided via a touch screen interface on the wireless game player 825. For instance, the wireless game player 825 may include a card reader for reading a player tracking card and player tracking identification information may be provided via a touch screen interface on the wireless game player. Further, the player may be able to access player tracking information using the wireless game player 825.

In addition to the devices described above, the top box 6 may contain different or additional devices than shown in the FIG. 9. For example, the top box may contain a bonus wheel or a back-lit silk screened panel which may be used to add bonus features to the game being played on the gaming machine. During a game, these devices are controlled and powered, in part, by circuitry (not shown) housed within the main cabinet 4 of the machine 2. It should be understood that gaming machine 2 is but one example from a wide range of gaming machine designs on which the present invention may be implemented. For example, not all suitable gaming machines have top boxes or player tracking features. Further, some gaming machines have two or more game displays—mechanical and/or video, while others are designed for bar tables and have displays that face upwards. As another example, a game may be generated in on a host computer and may be displayed on a remote terminal or a remote computer. The remote computer may be connected to the host computer via a network of some type such as the Internet. Those of skill in the art will understand that the present invention, as described below, can be deployed on most any gaming machine now available or hereafter developed.

Returning to the example of FIG. 9, when a user selects a gaming machine 2, he or she inserts cash through the coin acceptor 28 or bill validator 30. Additionally, the bill validator may accept a printed ticket voucher which may be accepted by the bill validator 30 as an indicium of credit. Once cash has been accepted by the gaming machine, it may be used to play a game on the gaming machine. Typically, the player may use all or part of the cash entered into the gaming machine to make a wager on a game play. Depending on the amount of the wager on a game or for a fee, a player may be able to access various entertainment content sources for a length of time. For example, a wager on a game above a certain threshold amount may enable a player to watch a broadcast event or to access the World Wide Web for up to 5 minutes after each wager on the gaming machine 2. In addition, cash or indicia of credit entered into the gaming machine may be used to purchase entertainment content independent of a wager made on a game on the gaming machine. For example, for a 10 dollar fee, a player may view a movie on the gaming machine. While watching the movie on the gaming machine, the player may play games on the gaming machine 2 or the wireless game player 825 or just watch the movie.

During the course of a game, a player may be required to make a number of decisions which affect the outcome of the game. For example, a player may vary his or her wager, select a prize, or make game-time decisions which affect the game play. These choices may be selected using the player-input switches 32, the main video display screen 34 or using some other device which enables a player to input information into the gaming machine including a key pad, a touch screen, a mouse, a joy stick, a microphone and a track ball.

When a game is not being played on the gaming machine or during particular game operational modes, the player may select an entertainment content source using the above mentioned inputs where the entertainment content is independent of a game being played on the gaming machine. The entertainment content source may include, for instance, a CD player, an FM/AM tuner, a VHS player, a DVD player, a TV tuner, a musical jukebox, a video jukebox, a computer, a server and a media software application. It will be appreciated, however, that any information source may be utilized. Entertainment content from these sources may be selected and displayed on the wireless game player 825. For instance, a player may listen to music from the FM/AM tuner via headphones connected to the wireless game player.

Before playing a game, a player may select the video jukebox, which may contain a DVD player loaded with many DVDs, as the entertainment content source and preview a movie on at least one of the display screens on the gaming machine 2. The DVDs may be stored on the gaming machine 2 or in a central location separate from the gaming machine. The visual display of the output from the video jukebox may be viewed by the player on the main video display screen 34, the secondary video display screen 42 or the remote display 828. The sound for the movie may be projected by the speakers 10, 12 and 14 on the gaming machine or a player may listen to the movie through headphones. As described above, the wireless game player 825 may include an interface for audio output such as a headphone jack.

The game player may also use the player input switches 32, keypad 22, and other input devices to control a feature of the entertainment content. For example, when the entertainment content is a movie, the player input switches 32 and keypad may be operated to fast forward, stop or pause the movie. When the entertainment content is accessing the World Wide Web through a web-browser, the player input switches 32 and keypad may be used to operate the web-browser. Input switches, as described with respect to FIG. 8, on the wireless game player 825 may also be used to control these functions.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, throbbing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18. When a player is using the wireless game player 825, credits available during the wireless game play session are stored on the gaming machine. To redeem credits, for instance to receive a printed ticket voucher, the player may have to return to the gaming machine 800 or a printing station supporting communications with the wireless game player 825. In some embodiments of the present invention, a player may be able to electronically transfer credits to a remote account accessible by the player.

FIG. 10 is a block diagram of the internal components of a gaming machine 2 and a wireless game player 825. Components that appear in FIGS. 8 and 9 are identified by common reference numerals. A master gaming controller 924 controls the operation of the various gaming devices and the game presentation on the gaming machine 2. In the present invention, the wireless game player 825 is one of the gaming devices the master gaming controller 924 controls. The master gaming controller 924 may communicate with the wireless game player 825 via a wireless communication link 952. The wireless communication link may use a wireless communication standard such as but not limited to IEEE 802.11a, IEEE 802.11b, IEEE 802.11x (e.g. another IEEE 802.11 standard such as 802.11c or 802.11e), hyperlan/2, Bluetooth, and HomeRF.

As described above, in the present invention, the gaming machine may operate in a local operational mode where a game is presented on a local display screen, such as 34 or 42, a remote operational mode where a game is presented on the wireless game player 825 or combinations thereof. When the gaming machine 2 is in a local operational mode, using a game code and graphic libraries stored on the gaming machine 2, the master gaming controller 924 generates a game presentation which is presented on the displays 34 and 42. The game presentation is typically a sequence of frames updated at a rate of 60 Hz (60 frames/sec). For instance, for a video slot game, the game presentation may include a sequence of frames of slot reels with a number of symbols in different positions. When the sequence of frames is presented, the slot reels appear to be spinning to a player playing a game on the gaming machine. The final game presentation frames in the sequence of the game presentation frames are the final position of the reels. Based upon the final position of the reels on the video display 34, a player is able to visually determine the outcome of the game.

Each frame in sequence of frames in a game presentation is temporarily stored in a video memory 936 located on the master gaming controller 924 or alternatively on the video controller 937. The gaming machine 2 may also include a video card (not shown) with a separate memory and logic system for performing graphic functions on the gaming machine. Typically, the video memory 936 includes 1 or more frame buffers that store frame data that is sent by the video controller 937 to the display 34 or the display 42. The frame buffer is in video memory directly addressable by the video controller. The video memory and video controller may be incorporated into a video card which is connected to the processor board containing the master gaming controller 924. The frame buffer may consist of RAM, VRAM, SRAM, SDRAM, etc.

The frame data stored in the frame buffer provides pixel data (image data) specifying the pixels displayed on the display screen. In one embodiment, the video memory includes 3 frame buffers. The master gaming controller 924, according to the game code, may generate each frame in one of the frame buffers by updating the graphical components of the previous frame stored in the buffer. Thus, when only a minor change is made to the frame compared to a previous frame, only the portion of the frame that has changed from the previous frame stored in the frame buffer is updated. For example, in one position of the screen, a 2 of hearts may be substituted for a king of spades. This minimizes the amount of data that must be transferred for any given frame. The graphical component updates to one frame in the sequence of frames (e.g. a fresh card drawn in a video poker game) in the game presentation may be performed using various graphic libraries stored on the gaming machine. This approach is typically employed for the rendering of 2-D graphics. For 3-D graphics, the entire screen is typically regenerated for each frame.

Pre-recorded frames stored on the gaming machine may be displayed using video “streaming”. In video streaming, a sequence of pre-recorded frames stored on the gaming machine is streamed through frame buffer on the video controller 937 to one or more of the displays. For instance, a frame corresponding to a movie stored on the game partition 928 of the hard drive 922, on a CD-ROM or some other storage device may streamed to the displays 34 and 42 as part of game presentation. Thus, the game presentation may include frames graphically rendered in real-time using the graphics libraries stored on the gaming machine as well as pre-rendered frames stored on the gaming machine 2.

When the gaming machine is in a remote operational mode and a game is presented on a display 826 of the mobile wireless game player 825, video frame data may be directly streamed from gaming machine 2 via the wireless interface 948 and wireless access point 950 to the wireless game player 825 via wireless interface 960. The video frame data may be stored in a memory 958 on the wireless game player 958 and then displayed on the display 825. The video frames sent to the wireless game player may be reduced in resolution and compressed to reduce the communication band-with necessary to transmit the video frames to the wireless game player 825.

In another embodiment, the video frames to present a game of chance may be rendered locally on the wireless game player 825. Graphical programs that allow a game to be rendered on the wireless game player may be stored in memory 958. For instance, the memory 958 may store a graphical program to render a slot game or a graphical program to render a card game. The memory 958 may store graphical programs for one or more games. For instance, the memory 958 may store graphical routines for a plurality of games supported by gaming machine 2. In one embodiment, the wireless game player 825 may be configured to allow different graphical programs for presenting different games to be downloaded into memory 958.

In other embodiments, the wireless gaming device may include a detachable memory and interface for the detachable memory. The detachable memory may store graphical applications for one or more games. Thus, to enable a particular game, a detachable memory storing graphical applications for the particular game may be inserted in the detachable memory interface on the wireless game player 825. The detachable memory may be in the form of read-only cartridges and may include a locking mechanism that prevents removal of the cartridge by the player. Thus, only authorized gaming personnel may be able to change a cartridge in the wireless game player.

The wireless game player may include a video card (not shown) to aid in the rendering process. The video card may include one or more graphical processing units that are used to render images to the display 826. The video card may be used to render 2-D graphics and 3-D graphics on the wireless game player 825. Graphical processing may also be performed by microprocessor 954 including 2-D and 3-D graphical rendering. Some images may be pre-rendered and stored on the wireless game player 825 and activated by a small string of commands from the gaming machine 2. Animations, such as reel rotation for a slot game, may be performed by routines on the wireless game player 825.

When the game graphics are rendered locally on the wireless game player 825, all of the game logic necessary to present the game of chance still resides on the gaming machine 2. Any switch or touch input necessary for game play on the wireless game player 825 (e.g., making a wager, initiating a game, holding cards, drawing cards, etc.) is transmitted 2 from the wireless game player 825 to the gaming machine 2. The gaming machine 2 executes gaming logic associated with the switch or touch inputs and sends the result back to the wireless game player 825. The wireless game player 825 verifies information sent from the gaming machine. In general, communication between the gaming machine 2 and the wireless game player 825 is encrypted. For any screen image or input involving the outcome of the game or betting, an additional level of transmit and receive data verification may be used by the wireless game player 825 and the gaming machine 2 to ensure the correct information is displayed on the wireless game player 825.

For illustrative purposes only, a series of commands between the gaming machine 2 and the wireless game player is described. The present invention is not limited to the commands described in this example. In response to input from player inputs 956 located on the wireless game player 825, the master gaming controller 924 may send a series of instructions to the wireless game player 825 that allow the game of chance to be rendered on display 826 of the wireless game player 825. The master gaming controller may also send instructions controlling audio output and other gaming devices on the wireless game player 825. For instance, for a slot game, the master gaming controller 924 may calculate symbol position, reel position, start and stop rotation for a number of reels. Then, the master gaming controller 925 may send one or more messages via the wireless communication link 952 to the wireless game player 825 with instructions such as 1) “render reels spinning”, 2) “render reel 1 at position A”, 3) “render reel 2 at position B”, 4) “render reel 3 at position C”, 5) “output audio B”, 6) “display light pattern A,” etc. The instructions may be processed and implemented by the microprocessor 954 using graphical software stored on the wireless game player 825.

In one embodiment, the wireless game player may be connected to a number of peripheral devices such as a printer 970 or a card reader 972. The printer 970 and the card reader 972 may communication with the wireless game player via a wire communication protocol such as serial, parallel, USB, Firewire or IEEE 1394. The peripheral devices, such as 970 and 972, may be controlled by the microprocessor 954 according to inputs received by the wireless game player and may also be controlled by the master gaming controller 924 on the gaming machine 2.

For gaming machines, an important function is the ability to store and re-display historical game play information. The game history provided by the game history information assists in settling disputes concerning the results of game play. A dispute may occur, for instance, when a player believes an award for a game outcome was not properly credited to him by the gaming machine. The dispute may arise for a number of reasons including a malfunction of the gaming machine, a power outage causing the gaming machine to reinitialize itself and a misinterpretation of the game outcome by the player. In the case of a dispute, an attendant typically arrives at the gaming machine and places the gaming machine in a game history mode. In the game history mode, important game history information about the game in dispute can be retrieved from a non-volatile storage on the gaming machine and displayed in some manner to a display on the gaming machine. The game history information is used to reconcile the dispute.

During the game presentation, the master gaming controller 924 may select and capture certain frames to provide a game history. These decisions are made in accordance with particular game code executed by controller 924. The captured frames may be incorporated into game history frames. Typically, one or more frames critical to the game presentation are captured. For instance, in a video slot game presentation, a game presentation frame displaying the final position of the reels is captured. In a video blackjack game, a frame corresponding to the initial cards of the player and dealer, frames corresponding to intermediate hands of the player and dealer and a frame corresponding to the final hands of the player and the dealer may be selected and captured as specified by the master gaming controller. Details of frame capture for game history applications are provided in U.S. Pat. No. 6,863,608, which is incorporated herein in its entirety and for all purposes.

In general, the gaming machine 2 maintains transaction logs of all events and game play. In some embodiments, as described above, the gaming machine may generate and store video frames as a game history record. The video frames may correspond to gaming information displayed on the wireless game player 825. During a wireless game play session, when the wireless game player 825 stops responding to the gaming machine 2, the game presented on the wireless game player 825 stops. The wireless game player 825 may stop responding to the gaming machine 2 because the wireless game player 825 is out-of-area reception, a battery level is low on the wireless game player, a power failure on the gaming machine 2 and other factors. To continue an interrupted game, the wireless game player 825 may ping the gaming machine 2 to reestablish communications and start the verification and authentication cycle as previously described. In the case of a dispute, the player may have to return to the gaming machine 2 so that game history records on the gaming machine can be accessed.

FIG. 11 is a block diagram of a network of gaming machines and wireless game players. Gaming machines 1065, 1066, 1067, 1068, 1069, 1075, 1076, 1077, 1078 and 1079, located in a floor area of casino 1005, support wireless game play and are connected to a wireless access point 1025. The gaming machines 1065, 1066, 1067, 1068, 1069, 1075, 1076, 1077, 1078 and 1079 are also connected to a player tracking system 1010 via a data collection unit 1055. Thus, game play on a wireless game player, such as 1020, in communication with one of the gaming machines on the casino floor may generate player tracking points. Further, a player using a game player, such as 1020, may be able to utilize services traditionally offered through player tracking devices on gaming machines such as a drink request. To provide the player tracking services, a player tracking service interface may be displayed on the touch screen of the wireless game player. Details of player tracking services and other gaming services that may be provided through a wireless game player of the present invention are described in U.S. Application No. 6,908,387, which is incorporated herein in its entirety and for all purposes.

The gaming machines located on the casino floor may also be connected to other remote servers such as but not limited to cashless system servers, progressive game servers, bonus game servers, prize servers, Internet, an entertainment content server, a concierge service server and a money transfer server and the like. Game services offered by the remote servers connected to the gaming machines may also be offered on wireless game players such as 1020. For instance, a game player may participate in a progressive game using the wireless game player 1020. In another example, a game player may be able to perform a cashless transaction enabled by a cashless system, such as the EZPAY™ cashless system (IGT, Reno Nev.), using a wireless game player.

In one embodiment, the gaming machines 1065, 1066, 1067, 1068, 1069, 1075, 1076, 1077, 1078 and 1079 connected to the access point 1025 are each provided with a wireless game player, such as 1020, 1021, 1022 and 1023. The gaming machines use a common wireless access point 1025. In this case, the access point device is also a multi-port switch. So, each machine has an Ethernet connection to the access point 1025.

In another embodiment of the present invention, an antenna may be built into a candle located on top of a gaming machine or some other location in the gaming machine. The antenna may be used as a wireless access point for wireless game play on one or more gaming machines. As an example, an antenna may be installed in the candle of gaming machine 1067 to be used as a wireless access point for wireless game play on gaming machines 1065, 1066, 1067, 1068 and 1069. A single gaming machine with an antenna may be used as part of a larger network of gaming devices providing wireless game play or may be used independently of a larger network. The antenna can, for example, be provided in accordance with the techniques described in the U.S. Pat. No. 5,605,506, entitled “CANDLE ANTENNA.”

To obtain a wireless game player on one of the gaming machines on the casino floor, a player may request a wireless game player via a service call on the gaming machine such as through the player tracking system. The request may go to a remote location, such as a terminal at a wireless game player attendant station 1015 and an attendant may then bring a wireless game player to the gaming machine where the request for wireless game play has been made. The request may be routed to the attendant station 1015 via the wireless game player server 1030. When a wireless game player server 1030 is not used, the request may be sent directly to the attendant station 1015. As another example, when a request for wireless game play is made, a light on the gaming machine such as the candle on top of the gaming machine may be activated. In this case, a passing attendant may bring the game player a wireless game player. In yet another embodiment, a player may make a request for a wireless game player on a terminal at a wireless game player kiosk 1016.

Prior to enabling the network connection for the wireless game play, a person or a system program may determine the customer is eligible to use the wireless game player and verify their eligibility. For instance, most gaming jurisdictions include age eligibility rules which must be obeyed. As another example, eligibility to use a wireless game player may be based upon a player's value to a casino such as a status in a player tracking club. When authentication is required, the information is loaded from the system (could be a smart-card reader on the gaming machine) or a message appears on the gaming machine instructing the customer to provide information. For example, the gaming machines could have a fingerprint sensor or another biometric device located on the front panel or elsewhere on the device. When required, the gaming machine could instruct the customer that it needs a fingerprint image or other biometric information before the customer may use the wireless game player. Information obtained through biometric sensors located on the gaming machine may be compared with information contained in a customer's biometric file. In some embodiments, the biometric information file may be downloaded to the gaming machine from a remote server and the biometric comparison may be performed on the gaming machine, the gaming machine may send biometric information to a remote server where the biometric comparison is performed, or combinations thereof.

In some instances, gaming machines supporting wireless game players may be located in a high-roller area (e.g., very valued customers) and the machines may have a specially designed stand where the wireless game players are stored. The wireless game players may be enabled by an attendant or may automatically be enabled when the casino customer inserts their player-tracking card into the gaming machine (special customer). As with the gaming machines located on the casino floor, the player-tracking system or some other remote gaming device may download the customer's biometric file to the gaming machine or the gaming machines could have a fingerprint sensor located on the front panel. When required, the gaming machine may instruct the customer that it needs a fingerprint image before the customer use the wireless game player.

To establish remote operations on the wireless game player, the gaming machine may ping the wireless game player with a series of communications. In one embodiment, once this operation is completed, the game play is transferred to the wireless game player. The screen of the gaming machines may go black (perhaps with a out-of-service message) and all customer cash and switch controls are locked out (nobody can use them). The master gaming controller on the gaming machine will continue to play the games, perform all the outcome determination and cash transaction (bets & credits), and maintains all the meter information. However, all the front panel and display data is channeled to the wireless game player. In one embodiment, when the gaming machines credit balance reaches zero, the customer is required to return to the gaming machine and insert more money. To enter more money, first, the local gaming machine controls are activated by the player or an attendant. In jurisdictions where the customer can use a debit or smart card to add money to a gaming machine, a card reader (smart card) connected to the wireless game player may be used to perform this function. In general, during a wireless game play session, the gaming machine communicates continuously with the wireless game player. In one embodiment, a web browser is used to display input switch commands. The displayed information on the wireless game player may transfer from the gaming machine as HTML-encoded page information. Therefore, the wireless game player may use web-based transactions.

Additional details of a wireless game play network are described in the following paragraphs. The wireless game play network is shown in FIG. 11 is only one example of many possible embodiments of the present invention. The gaming machines and other gaming devices supporting wireless game play on wireless game players comprise a wireless game play network. The wireless game play network may be a part of a larger system network. The larger system network may provide the capability for a large number of gaming machines throughout a casino to be on the same wireless game play network. High-gain antennas and repeaters may be used to expand the range of the wireless game players allowing them to work in all areas of a casino/hotel complex, including hotels rooms and pool area. Racetracks, large bingo parlors and special outdoor events may also be covered within the wireless game play network allowing wireless game play in these areas.

The wireless game play network may also include wired access points that allow a wireless game player to be plugged directly into the network. For example, a wireless game player may include an Ethernet connector that may be directly plugged into the network segment 1046. The direct network connectors may be provided with cradles used to charge the wireless game player. The charging cradles may be located at many locations within the wireless game play network.

In FIG. 11, the range of the wireless access point 1025 is denoted by a circle 1047 used in the wireless game play network. Many such access points may be used in a wireless game play network depending upon the network topography. For instance, due the size of a particular casino and the area covered by a single access point, there could be other access points used as repeaters located throughout the casino and hotel. In addition, the wireless access point could also be connected to an existing network. After receiving an active wireless game player, a player may use the wireless game player in the areas of casino 1005 within the circle 1047. Further, the player may use the wireless game player, if approved by a local gaming jurisdiction, in the areas of a keno parlor 1007, a restaurant 1009, and a hotel 1011, which are within the circle 1047. While using the wireless game player, a player may wander to different locations within circle 1047 such as from the casino 1005 to the restaurant 1009.

In general, wireless game play in the wireless game play network is enabled by gaming devices executing licensed and regulated gaming software. However, the gaming devices supporting wireless game play are not limited gaming machines, such as 1065, 1066, 1067, 1068, 1069, 1075, 1076, 1077, 1078 and 1079 located on a casino floor. Special wireless-only gaming machines 1035 mounted in racks or containers connected to a wireless gaming network may be used to support wireless game play using wireless game players. The wireless-only gaming machines 1035 may not offer local game play. For instance, the wireless-only gaming machines 1035 may not include display screens. However, the wireless-only gaming machines are still regulated and licensed in a manner similar to traditional gaming machines. As another example, a wireless game player server 1030 with multiple processors may be used to support simultaneous game play on a plurality of wireless game players. The wireless-only gaming machines 1035 and the wireless game play server 1030 may be located in a restricted area 1030 of the casino 1005 and may not be generally accessible to game players.

The wireless-only gaming machines 1035 and wireless game play server 1030 are connected the wireless access point 1025 via a connection 1046. The wireless-only gaming machines 1035 and wireless game play server are also in communication with a wireless game player attendant station 1015 and the player tracking and accounting server 1010 via network connection 1045. The wireless-only gaming machine and wireless game player server 1030 may also be connected to other remote gaming devices such as progressive servers, cashless system servers, bonus servers, prize servers and the like.

When using a wireless-only gaming machine, the customer may use a kiosk, such as 1016 or a cashier to enter cash and provide authentication information for a wireless game play session using a wireless game player. Then, the customer may be assigned a wireless game player, such as 1020, 1021, 1022 and 1023, in communication with one of the wireless-only gaming machines 1035 or the wireless game play server 1030. Once authenticated and verified, the customer may select a game and begin playing the wireless game player. There may be wireless game play cradles in the keno parlor 1022, restaurant 1009 or Sports Book areas, allowing the customer to play their favorite casino machine game and at the same time make keno or Sports Book bets or eat. In addition, the wireless game play cradles may be used to charge batteries on the wireless game player and may also be used to provide an additional network access point such as through a wire connection provided on the cradle. The wireless game player may also be used for Sports Book and Keno betting. Thus, a player may watch a horserace or see the results of a certain event on the display of the wireless game player.

Finally, the wireless game player may also be used for other activities besides gaming. For example, because of the authentication and verification (security) features, the wireless game player could be safe way to conduct monetary transactions such as electronic funds transfers. As another example, the wireless game player may be used for video teleconferencing to visually connect to a casino host or to provide instant messaging services. In addition, when the wireless game player supports web-based browsers and the wireless game play network includes Internet access, the wireless game player may be used to obtain any web-based services available over the Internet.

Referring now to FIG. 12, an exemplary network infrastructure for providing a gaming system having one or more gaming machines is illustrated in block diagram format. Exemplary gaming system 1150 has one or more gaming machines, various communication items, and a number of host-side components and devices adapted for use within a gaming environment. As shown, one or more gaming machines 1110 adapted for use in gaming system 1150 can be in a plurality of locations, such as in banks on a casino floor or standing alone at a smaller non-gaming establishment, as desired. Common bus 1151 can connect one or more gaming machines or devices to a number of networked devices on the gaming system 1150, such as, for example, a general-purpose server 1160, one or more special-purpose servers 1170, a sub-network of peripheral devices 1180, and/or a database 1190.

A general-purpose server 1160 may be one that is already present within a casino or other establishment for one or more other purposes beyond any monitoring or administering involving gaming machines. Functions for such a general-purpose server can include other general and game specific accounting functions, payroll functions, general Internet and e-mail capabilities, switchboard communications, and reservations and other hotel and restaurant operations, as well as other assorted general establishment record keeping and operations. In some cases, specific gaming related functions such as cashless gaming, downloadable gaming, player tracking, remote game administration, video or other data transmission, or other types of functions may also be associated with or performed by such a general-purpose server. For example, such a server may contain various programs related to cashless gaming administration, player tracking operations, specific player account administration, remote game play administration, remote game player verification, remote gaming administration, downloadable gaming administration, and/or visual image or video data storage, transfer and distribution, and may also be linked to one or more gaming machines, in some cases forming a network that includes all or many of the gaming devices and/or machines within the establishment. Communications can then be exchanged from each adapted gaming machine to one or more related programs or modules on the general-purpose server.

In one embodiment, gaming system 1150 contains one or more special-purpose servers that can be used for various functions relating to the provision of cashless gaming and gaming machine administration and operation under the present methods and systems. Such a special-purpose server or servers could include, for example, a cashless gaming server, a player verification server, a general game server, a downloadable games server, an outcome server for remote gaming machines, a specialized accounting server, and/or a visual image or video distribution server, among others. Of course, these functions may all be combined onto a single specialized server. Such additional special-purpose servers are desirable for a variety of reasons, such as, for example, to lessen the burden on an existing general-purpose server or to isolate or wall off some or all gaming machine administration and operations data and functions from the general-purpose server and thereby increase security and limit the possible modes of access to such operations and information.

Alternatively, exemplary gaming system 1150 can be isolated from any other network at the establishment, such that a general-purpose server 1160 is essentially impractical and unnecessary. Under either embodiment of an isolated or shared network, one or more of the special-purpose servers are preferably connected to sub-network 1180, which might be, for example, a cashier station or terminal. Peripheral devices in this sub-network may include, for example, one or more video displays 1181, one or more user terminals 1182, one or more printers 1183, and one or more other input devices 1184, such as a ticket validator or other security identifier, among others. Similarly, under either embodiment of an isolated or shared network, at least the specialized server 1170 or another similar component within a general-purpose server 1160 also preferably includes a connection to a database or other suitable storage medium 1190. Database 1190 is preferably adapted to store many or all files containing pertinent data or information regarding cashless instruments such as tickets, among other potential items. Files, data and other information on database 1190 can be stored for backup purposes, and are preferably accessible at one or more system locations, such as at a general-purpose server 1160, a special purpose server 1170 and/or a cashier station or other sub-network location 1180, as desired.

While gaming system 1150 can be a system that is specially designed and created new for use in a casino or gaming establishment, it is also possible that many items in this system can be taken or adopted from an existing gaming system. For example, gaming system 1150 could represent an existing cashless gaming system to which one or more of the inventive components or program modules are added. In addition to new hardware, new functionality via new software, modules, updates or otherwise can be provided to an existing database 1190, specialized server 1170 and/or general-purpose server 1160, as desired. In this manner, the methods and systems of the present invention may be practiced at reduced costs by gaming operators that already have existing gaming systems, such as an existing EZ Pay® or other cashless gaming system, by simply modifying the existing system. Other modifications to an existing system may also be necessary, as might be readily appreciated.

The various aspects, features, embodiments or implementations of the invention described above can be used alone or in various combinations.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

We claim:

1. A wireless gaming management system for managing a wireless gaming network, wherein said wireless gaming management system comprises:
a data collection component operable to:
monitor a wireless gaming network for wireless transmissions made in wireless gaming network including wireless transmission to and/or from at least a first gaming device in said wireless gaming network, wherein said first gaming device is operable to receive wireless transmissions at least from a second device and obtain an outcome of a game managed by a gaming entity;
obtain at least wireless transmissions made to and from said first gaming device as collected transmission data;
a data storage and processing component operable to:
obtain said collected transmission data from said data collection component;
process said collected data; and
manage said wireless gaming network based on said processing of said collected data.

2. The wireless gaming management system of claim 1, wherein said managing of said gaming network comprises:
securing said gaming network against unauthorized access and/or unauthorized devices;
changing a mode and/or manner of communication in said gaming network; and
generating and providing alerts regarding said gaming network.

3. The wireless gaming management system of claim 1, wherein said securing of gaming network comprises one or more of the following:
detecting unauthorized communication in said wireless gaming network,
detecting unauthorized data transmissions,
detecting an unauthorized device,
detecting unauthorized communication by an authorized device,
detecting unauthorized data transmissions by an authorized device,
detecting unauthorized communication by an unauthorized device, or
detecting unauthorized data transmissions by an unauthorized device.

4. The wireless gaming management system of claim 1,
wherein said obtaining of said wirelessly transmitted data comprises: collecting content of data transmitted in said wireless gaming network and/or collecting one or more attributes regarding wireless transmission in said wireless gaming network; and
wherein said managing of said wireless gaming network comprises: determining, based on said content of data transmitted and/or one or more attributes of transmission, whether an attempt has been made to breach the security of said wireless gaming network and/or whether the security of said wireless gaming network has been breached.

5. The wireless gaming management system of claim 3, wherein said one or more attributes regarding said wireless transmission include one or more of the following:
one or more attributes associated with said signal transmission,
one or more attributes associated with signal transmission of a wireless transmission,
strength of signal transmission,
strength of wireless signal transmission,
channel of transmission,
channel of wireless signal transmission,
one or more attributes associated with transmitted content,
one or more attributes associated with content transmitted wirelessly,
encryption keys used to encrypt said transmitted content,
rate of data transfer,
originating location of transmission,
proximity of transmission, or
one or more identifiers associated with one or more devices transmitting said wireless transmission.

6. The wireless gaming management system of claim 1, wherein said data collection component includes an endpoint component operable to collect content wirelessly transmitted and/or one or more attributes regarding wireless transmissions to and from said first gaming device.

7. The wireless gaming management system of claim 1, said data collection component includes one or more ZigBee end-devices configured to transmit and receive messages but not operable to perform any routing operations.

8. The wireless gaming management system of claim 7, wherein said one or more ZigBee end-devices are operable to transmit said collected data to one or more ZigBee coordinator devices that are operable to effectively initiate and/or control said wireless gaming network.

9. The wireless gaming management system of claim 8, wherein said one or more ZigBee coordinator devices are further operable to receive and store said collected data.

10. The wireless gaming management system of claim 8, wherein said one or more ZigBee coordinator devices are further operable to perform one or more of the following:
store information regarding said wireless gaming management system,
store information regarding said wireless gaming network,
receive said collected data,
store said collected data,
process said collected data,
send said collected data to one or more processing components for processing,
provide access to said collected data, or
allow one or more processing components to access said collected data.

11. The wireless gaming management system of claim 1, wherein said data storage and processing component includes a data storage (or data concentrator) component operable to store said collected data, and a data processing component operable to obtain and/or process said collected data.

12. The wireless gaming management system of claim 1, wherein the data processing component includes a server component.

13. The wireless gaming management system of claim 1, wherein said data collection component is configured not to interfere with operations relating to said game.

14. The wireless gaming management system of claim 1, wherein said data collection component cannot access said first gaming device.

15. The wireless gaming management system of claim 1, wherein said data collection component cannot interfere with gaming operations of said first gaming device.

16. The wireless gaming management system of claim 1, wherein said data collection component includes an endpoint component operable to monitor wireless transmissions to said first gaming device but not operable to interfere with the gaming operations of said first gaming device.

17. The wireless gaming management system of claim 1, wherein said data collection component includes an endpoint component operable to monitor wireless transmissions to and/or from said first gaming device, and wherein said endpoint component is operable to communicate only with said data storage and processing component.

18. The wireless gaming management system of claim 1, wherein said endpoint component is a ZigBee endpoint that is operable to communicate only with one or more designated ZigBee coordinators of said data storage and processing component.

19. The wireless gaming management system of claim 1, wherein said game is a wagering game.

20. The wireless gaming management system of claim 1, wherein said game is a game of chance.

21. A method for managing a wireless gaming network, wherein said wireless gaming network includes at least a first gaming device operable to receive wireless transmissions from at least a second device and obtain an outcome of a game managed by a gaming entity, said method comprising:
monitoring transmission made in said wireless gaming network including wireless transmissions made to and from said first gaming device;
obtaining, based on said monitoring, wireless transmission data pertaining to wireless transmissions made to a first gaming device; and
managing said wireless gaming network based on said wireless transmission data.

22. The method of claim 21, wherein said monitoring of said wireless transmissions comprises monitoring transmissions to and/or from said first gaming device without interfering with said outcome of said game.

23. The method of claim 21, wherein said monitoring of said wireless transmissions is performed by an endpoint device that cannot access said first gaming device.

24. The method of claim 23, wherein said endpoint device cannot be accessed by any other device, and wherein said endpoint device is operable to send said transmission data to another device.

25. The method of claim 23, wherein said endpoint device cannot be accessed by any other device except a data storage/processing system, and wherein said endpoint device is operable to send said transmission data to another device.

26. The method of claim 25, wherein said another device and/or system includes a data storage component operable to store said transmission data.

27. The method of claim 25, wherein said another device and/or system further includes a processing component operable to process said transmission data.

28. The method of claim 21, wherein said obtaining comprises:
collecting said wireless transmission data as collected transmission data; and
providing said collected data for processing.

29. The method of claim 21, wherein said managing of said wireless gaming network comprises:
processing said collected data; and
determining, based on said processing of said collected data, whether unauthorized transmission has been transmitted to said first gaming device.

30. The method of claim 21, wherein said method further comprises:
processing said wireless transmission data; and
determining, based on said processing of said wireless transmission data, whether an authorized transmission has been transmitted to said first gaming device.
